(19) United States
(12) Patent Application Publication
(10) Pub. No.: US 2006/0193588 A1
(43) Pub. Date: Aug. 31, 2006

(54) Fiber access terminal

(76) Inventors: Daniel Ray Mertesdorf, Nicollet, MN (US); Thomas C. Tinucci, Eden Prairie, MN (US)

Correspondence Address: MERCHANT & GOULD PC, P.O. BOX 2903, MINNEAPOLIS, MN, 55402-0903, US

(21) Appl. No.: 11/068,724

(22) Filed: Feb. 28, 2005

(51) Int. Cl. G02B 6/00

(52) U.S. Cl. 385/135

(57) ABSTRACT

A fiber access terminal includes a drop cable side and a distribution cable side. The sides are separated by a frame to which a variety of cable management and cable connection components may be mounted. Optical fibers are routed from drop and distribution cables through a plurality of routing paths to splice trays for connection to other optical fibers. A protective cover over the distribution side of the frame is included.

### TECHNICAL FIELD

The present invention relates generally to provision of optical fiber telecommunications service. More specifically, the present invention relates to a fiber access terminal and a method of using a fiber access terminal.

### BACKGROUND

As demand for telecommunications services increases, optical fiber services are being extended into more and more areas. To more efficiently extend fiver optic service into areas where current and future customers are located, often distribution cables with more than one optical fiber are utilized. To provide service to a particular premises in the area, the distribution cables may be received within a fiber access terminal. Such terminals provide a location on the field where one or more optical fibers of the distribution cable may be split out from the distribution cable. The remainder of the fibers within the distribution cable may then be expressed through the fiber access terminal to extend to another location where service is desired.

Within the fiber access terminal, it is desirable to improve cable management and routing of the optical fibers expressed through as well as those being terminated within the fiber access terminal. It is also desirable to provide some security to the optical fibers of the distribution cables extending into the fiber access terminal to prevent accidental or malicious damage to optical fibers inside the fiber access terminal.

### SUMMARY

The present invention relates to a fiber access terminal including a drop cable side and a distribution cable side. The sides are separated by a frame to which a variety of cable management and cable connection components may be mounted. Optical fibers are routed from drop and distribution cables through a plurality of routing paths to splice trays for connection to other optical fibers. A protective cover over the distribution side of the frame is included. The present invention also relates to a method of routing a fiber optic cable within a fiber access terminal.

### BRIEF DESCRIPTION OD THE DRAWINGS

The accompanying drawings, which are incorporated in and constitute a part of the specification, illustrate several aspects of the present invention and together with the description, serve to explain the principles of the invention. A brief description of the drawings is as follows:

FIG. 1 is a perspective view of a fiber access terminal according to the present invention, shown with a stake mounting arrangement.

FIG. 2 is a first perspective view of the fiber access terminal of FIG. 1, with a cover partially exploded.

FIG. 3 is a second perspective view of the fiber access terminal of FIG. 1, with the cover partially exploded.

FIG. 4 is a first partially exploded perspective view of the fiber access terminal of FIG. 1.

FIG. 5 is a second partially exploded perspective view of the fiber access terminal of FIG. 4.

FIG. 6 is a first perspective view of the fiber access terminal of FIG. 1, with the cover removed and a first alternative arrangement of structures mounted to a drop cable side of the frame.

FIG. 7 is a second perspective view of fiber access terminal of FIG. 6.

FIG. 8 is a view of the drop cable side of the fiber access terminal of FIG. 6.

FIG. 9 is a view of the fiber access terminal of FIG. 6, rotated approximately ninety degrees from FIG. 8.

FIG. 10 is a view of a distribution cable side of the fiber access terminal of FIG. 6.

FIG. 11 is a view of the fiber access terminal of FIG. 6, rotated approximately ninety degrees from FIG. 10.

FIG. 12 is a top view of the fiber access terminal of FIG. 6.

FIG. 13 is a closer view of the drop cable side of the fiber access terminal of FIG. 5, with a customer drop cable extending into the enclosure and routed to a splice tray positioned on the frame.

FIG. 14 is a closer view of a splice holder of the drop cable side of the fiber access terminal of FIG. 13.

FIG. 15 is a closer view of an array of fiber optic adapters of the drop cable side of the fiber access terminal of FIG. 13.

FIG. 16 is a view of the drop cable side of the frame of the fiber access terminal of FIG. 6, with a second alternative arrangement of structures mounted to the drop cable side of the frame, and a plurality of cable pigtails extending from the distribution cable side of the frame through the frame to the adapters on the drop cable side of the frame.

FIG. 17 is a view of the drop cable side of the frame of FIG. 16, mounted to a base with the cable pigtail from the distribution side removed for clarity and including a plurality of optical fibers extending to the adapters.

FIG. 18 is a closer view of the array of adapters of the frame of FIG. 17.

FIG. 19 is a first partially exploded perspective view of the distribution cable side of the fiber access terminal of FIG. 6, with a third alternative arrangement of structures mounted to the drop cable side of the frame and a distribution cable side cover removed.

FIG. 20 is a second partially exploded perspective view of the drop cable side of the fiber access terminal of FIG. 19.

FIG. 21 is a closer view of a splice holder and cable management sub-assembly mounted to the frame of the fiber access terminal of FIG. 19.

FIG. 22 is a view of the distribution cable side of the frame of the fiber access terminal of FIG. 20, with optical fibers extending from the splice holder through the frame to the drop cable side of the frame.

FIG. 23 is a closer view of the splice holder mounted to the frame of FIG. 22.

FIG. 24 is a view of the distribution cable side of the fiber access terminal of FIG. 19, with some optical fibers from distribution cables expressed through the enclosure, and other optical fibers extending into the enclosure and to the splice holder mounted to the frame.

FIG. 25 is a view of the distribution side of the fiber access terminal of FIG. 24, with some optical fibers from distribution cables expressed through the enclosure, and other optical fibers extending into the enclosure and through the frame to the drop cable side of the frame.

FIG. 26 is a closer view of the splice holder on the distribution side of the fiber access terminal of FIG. 25.

FIG. 27 is a view of the drop cable side of the fiber access terminal of FIG. 20, with a customer drop cable entering the enclosure and an optical fiber from the drop cable extending to the splice holder.

FIG. 28 is a view of the drop cable side of the fiber access terminal of FIG. 20, with optical fibers extending from the distribution cable side through the frame and routed to the splice holder on the drop cable side of the frame.

FIG. 29 is a perspective view of an alternative embodiment of a fiber access terminal according to the present invention.

FIG. 30 is a first perspective view of the fiber access terminal of FIG. 29, with the cover partially exploded.

FIG. 31 is a second perspective view of the fiber access terminal of FIG. 30.

FIG. 32 is a perspective view of a distribution cable side of the fiber access terminal of FIG. 29, with the cover removed and a distribution cable side cover in place.

FIG. 33 is a perspective view of a drop cable side of the fiber access terminal of FIG. 32.

FIG. 34 is a first perspective exploded view of the fiber access terminal of FIG. 29.

FIG. 35 is a second perspective exploded view of the fiber access terminal of FIG. 29.

FIG. 36 is a perspective view of the drop cable side of the fiber access terminal of FIG. 34, with the cover removed and a removable corner of the base exploded.

FIG. 37 is a view of the drop cable side of the fiber access terminal of FIG. 32.

FIG. 38 is a view of the fiber access terminal of FIG. 32, rotated approximately ninety degrees from FIG. 37.

FIG. 39 is a view of the distribution cable side of the fiber access terminal of FIG. 32.

FIG. 40 is a view of the fiber access terminal of FIG. 32, rotated approximately ninety degrees from FIG. 39.

FIG. 41 is a top view of the fiber access terminal of FIG. 32.

FIG. 42 is a second perspective view of the drop cable side of the fiber access terminal of FIG. 41, with the splice holder assembly exploded from the frame.

FIG. 43 is a perspective view of the distribution side of the fiber access terminal of FIG. 39, with the distribution side cover removed and a vertical splice tray assembly exploded from the frame.

FIG. 44 is a view of the drop cable side of the fiber access terminal of FIG. 42.

FIG. 45 is a view of the distribution cable side of the fiber access terminal of FIG. 44.

### DETAILED DESCRIPTION

Reference will now be made in detail to the exemplary aspects of the present invention that are illustrated in the accompanying drawings. Wherever possible, the same reference numbers will be used throughout the drawings to refer to the same or like parts.

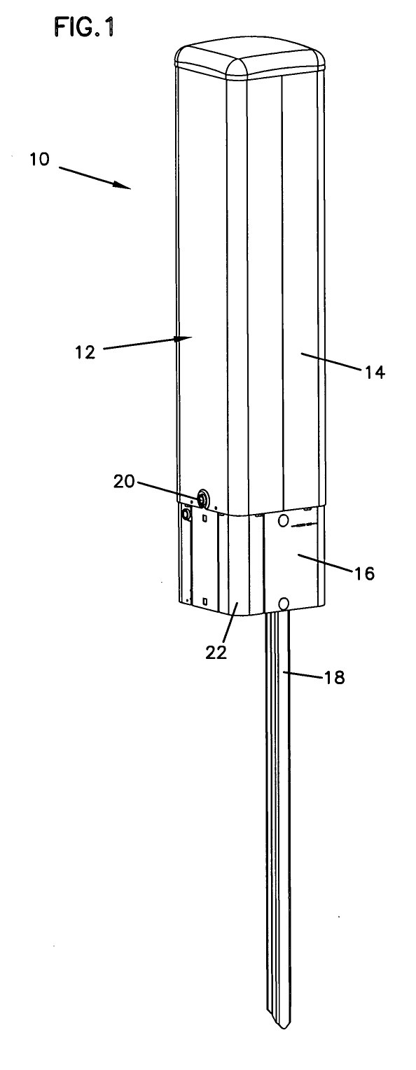

Fiber access terminals such as terminal 10 of FIG. 1, may be used in the extension of fiber optic service to customers. Terminal 10 includes an enclosure 12 with a cover 14 and a base 16 cooperating to define an interior. Cover 14 is removable from base 16 to permit access into the interior and telecommunications equipment which may be housing within enclosure 12. Terminal 10 is configured to be mounted in the field and receive a multi-fiber fiber optic service distribution cable through a base 16. Stake 18 is connected to base 16 and is configured to be inserted into the ground at a desired location proximate an optical fiber distribution cable. Cover 14 is removable held to base 16 by at least one security screws or fasteners 20, which are illustrated as screws with can or security washers to discourage unauthorized access. Base 16 also includes a removable corner 22 along one side of enclosure 12 to permit ease of entry of customer drop cables that may be extended to terminal 10 at a later date, after the initial installation. Removable corner 22 may be removed from base 16 once cover 14 has been removed from base 16.

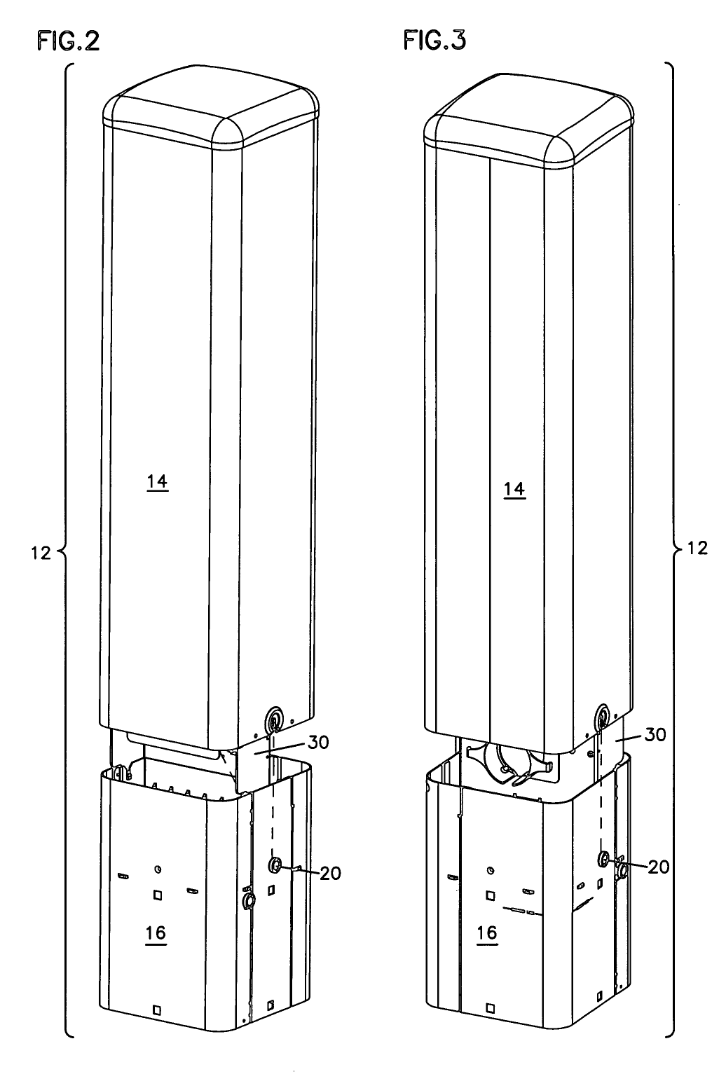

FIGS. 2 and 3 illustrate enclosure 12 with cover 14 partially removed to show a frame 30 within the interior of enclosure 12. Removal of cover 14 from base permit a user to access components mounted within enclosure 12 to frame 30. An example of the components or structures which may be mounted to frame 30 is shown in FIGS, 4 to 28, below. These components are described in further detail below.

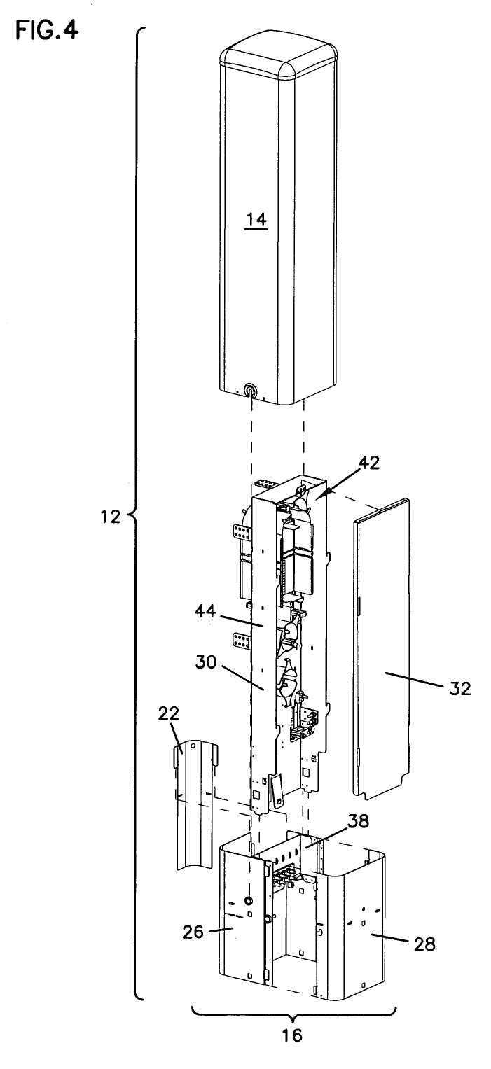

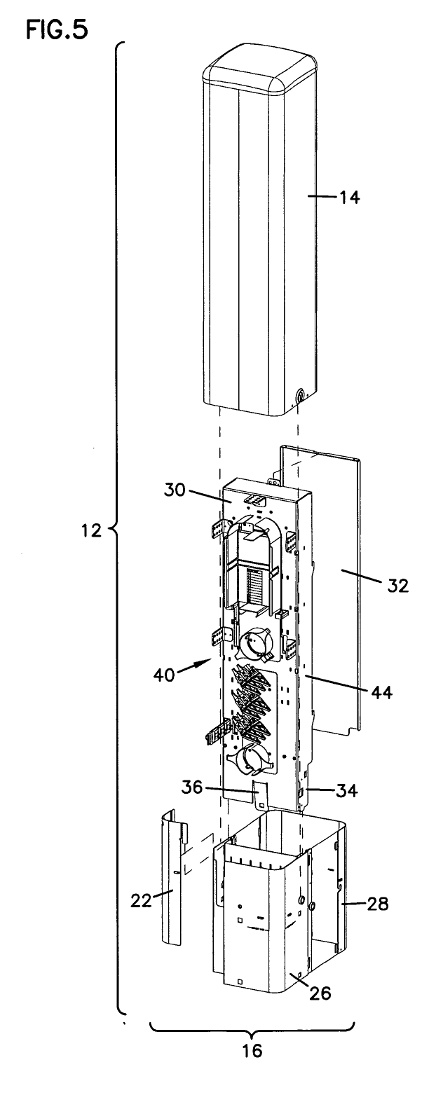

FIGS. 4 and 5 show exploded views of enclosure 12 with base 16 including a first fixed portion 26 and a second removable portion 28. When terminal 10 is installed in the field adjacent an existing trenched in or buried optical fiber distribution cable, base 16 may be positioned directly alongside a loop of the cable that has been extended above grade and stake 18 driven into the ground to an appropriate depth for the installation. This split base design cooperates with a loop of distribution cable so that the distribution cable will not have to be cut, spliced or otherwise altered to extend within terminal 10. Frame 30 includes two opposing sides, a first or distribution cable side 42 and a second or drop cable side 40. Frame 30 may also include a pair of side extensions 44 that provide lateral support to the frame within enclosure 12 and also engage a protective distribution cable cover 32. Cover 32 is intended to reduce and prevent damage that may occur to the distribution cable from accidental or intentional damage.

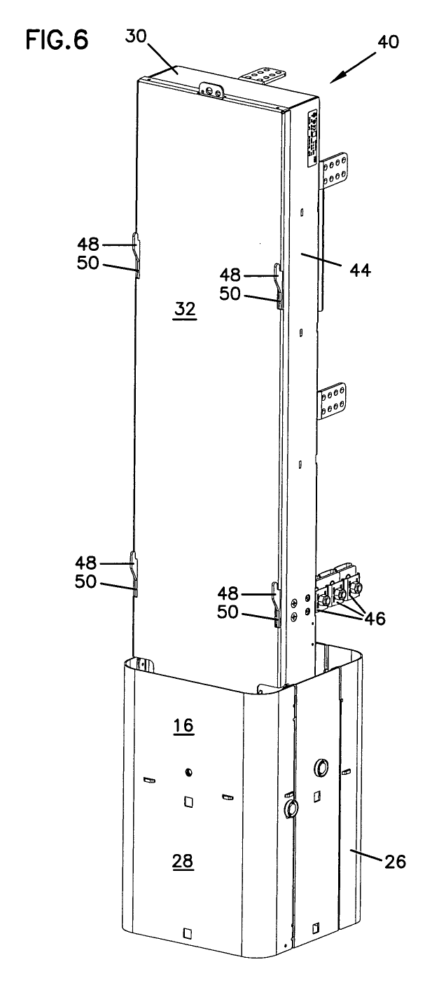

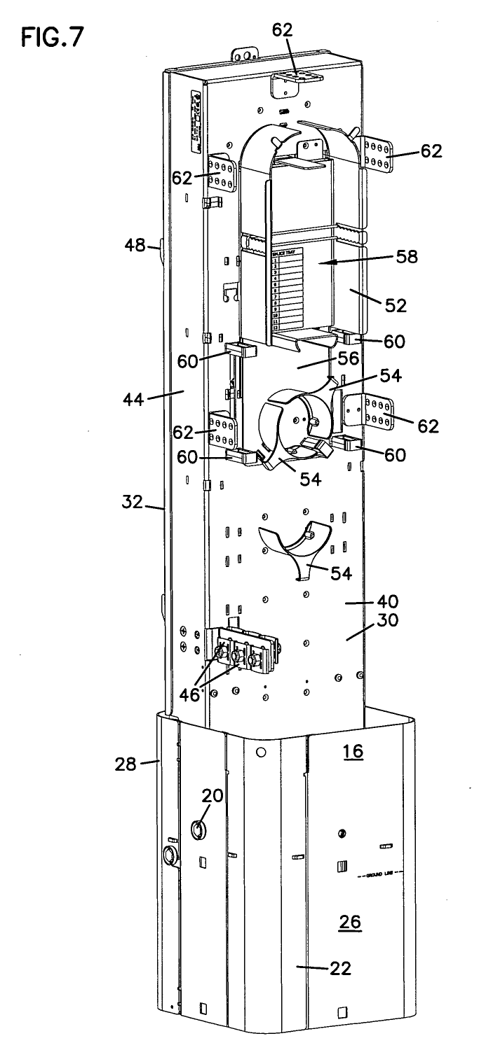

Frame 30 includes a lower mating portion 34 with a locking tab 36. Lower portion 34 engages a frame mount 38 of fixed portion 26, mounting frame 30 to base 16. Frame 30 also may include a plurality of hooks 48 extending from side extensions 44 which engage mating openings 50 in cover 32, as shown in FIGS. 6 and 7. One or more cable clamps 46 may be mounted to drop cable side 40 to permit fiber optic drop cables from customers to be secured to frame 30 once these cables are extended through base 16.

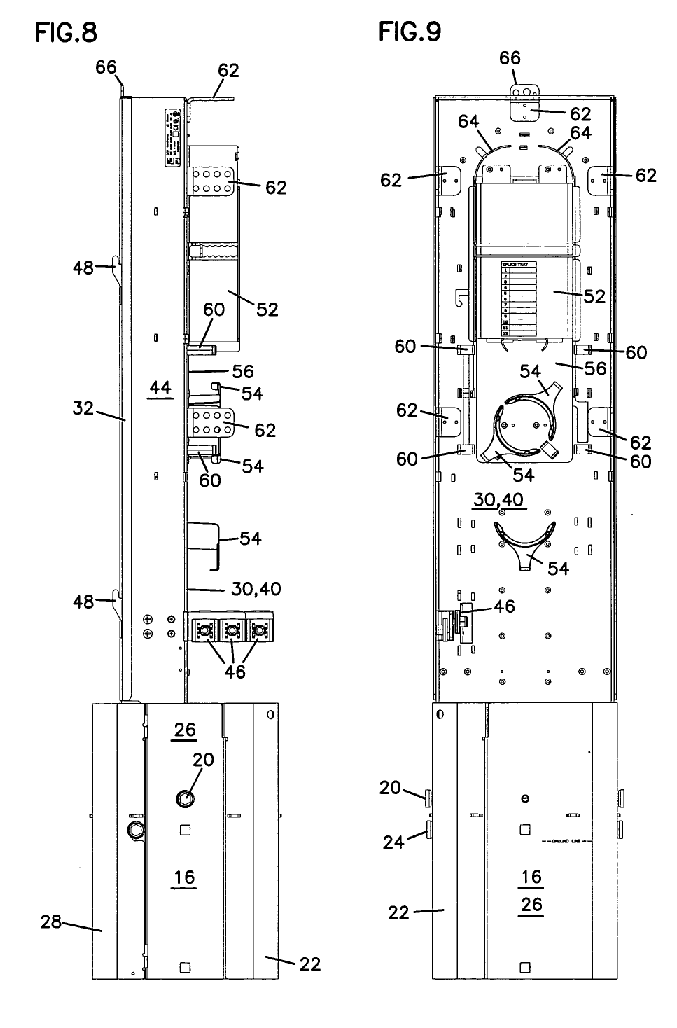

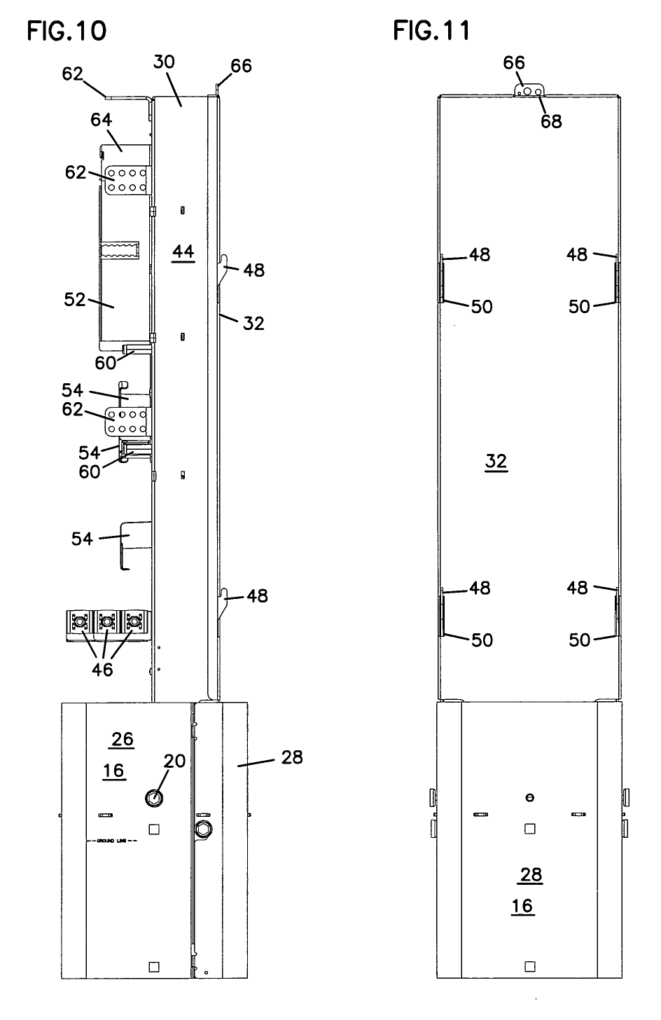

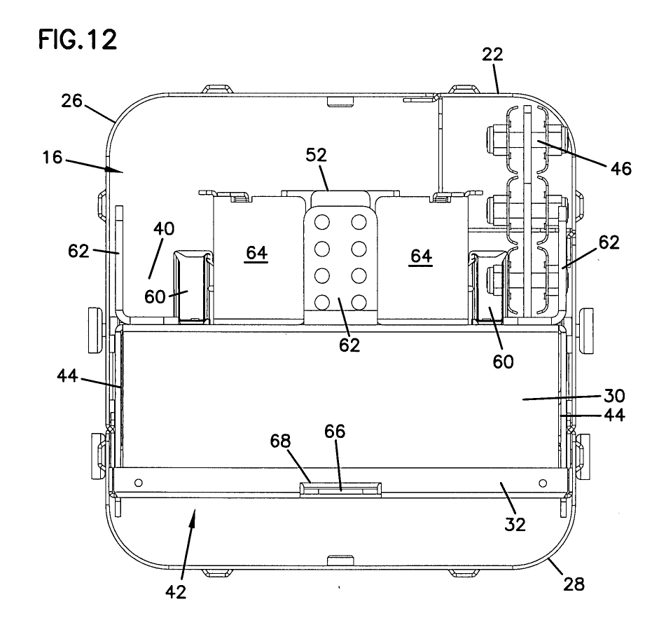

In FIGS. 7 through 12, different components or structures mounted to drop cable side 40 of frame 30 are shown, including a splice holder 52 and one or more cable routing shapes 54. In the interest of clarity, individual splice trays for splicing optical fiber, which are well known in the industry, have been omitted from the drawings. It is understood that any reference to splice holder 52 may also include such splice trays ars may be inserted within the splice holder and used to connect to segments of optical fiber. Splice holder 52 and one or more of the routing shapes or cable management structures 54 may be mounted to a plate 56 which is in turn mounted to frame 30 as a modular component 58. Routing shapes 54 may also be augmented by cable routing clips 60 on drop cable side 40 of frame 30 to define one or more cable paths for optical fibers of customer drop cables clamped to cable clamps 46 and extending within enclosure 12. Cable routing clips 60 are shown in more detail in commonly owned U.S. Pat. Nos. 6,539,161 and 6,768,858, the disclosures of which are incorporated herein by reference. Splice holder 56 is configured to receive a plurality of fiber optic splice trays and store them generally parallel to drop cable side 40 of frame 30. A plurality of tabs or cable tie-offs 62 may also be mounted to drop cable side 40 so that fiber optic cables from incoming drop cables held by cable clamps 46 may be routed along side 40 in an organized and secure fashion.

Splice holder 52 may also include one or more curved upper portion 64 to aid in routing fiber optic cables about the top of frame 30, providing bend radius protection and preventing routed cables from tangling with splice holder 52. A lock tab 66 may be included at a top of frame 30 and positioned to extend through an opening 68 in cover 32. A lock, a tamper-indicating device, or other securing device may be attached to lock tab 66 to prevent cover 32 from being removed from about distribution cable side 42 of frame 30.

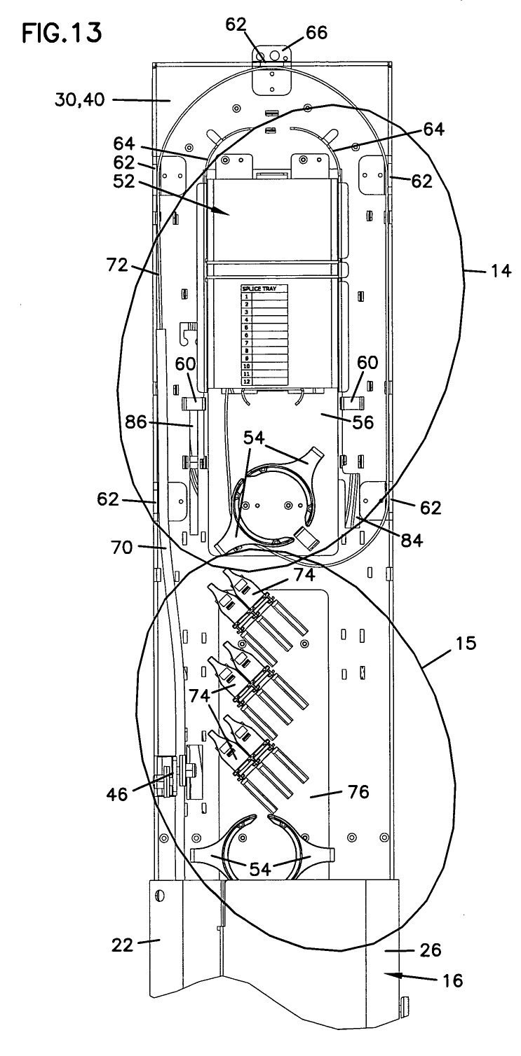

Referring now to FIGS. 13 to 15, an alternative configuration of devices and structures are shown mounted to drop cable side 40 of frame 30. In these FIGS. 13 to 15, plate 56 with splice holder 52 and cable management structures 54 is mounted as shown in the FIGS., above. A second mounting plate 76 with a plurality of adapters in adapters packs 74 and a pair of cable management structures 54 is mounted between plate 56 and base 16. A customer drop cable 70 extends up through base 16 and is clamped to one of the cable clamps 46. One or more optical fibers 72 may be within drop cable 70 and may be routed about frame 30 above splice holder 52, and may also be secured to cable tie-offs 62. Optical fibers 72 are directed from drop cable 70 into splice holder 52 where they may be spliced to fibers connected to a distribution cable to provide optical service to a customer.

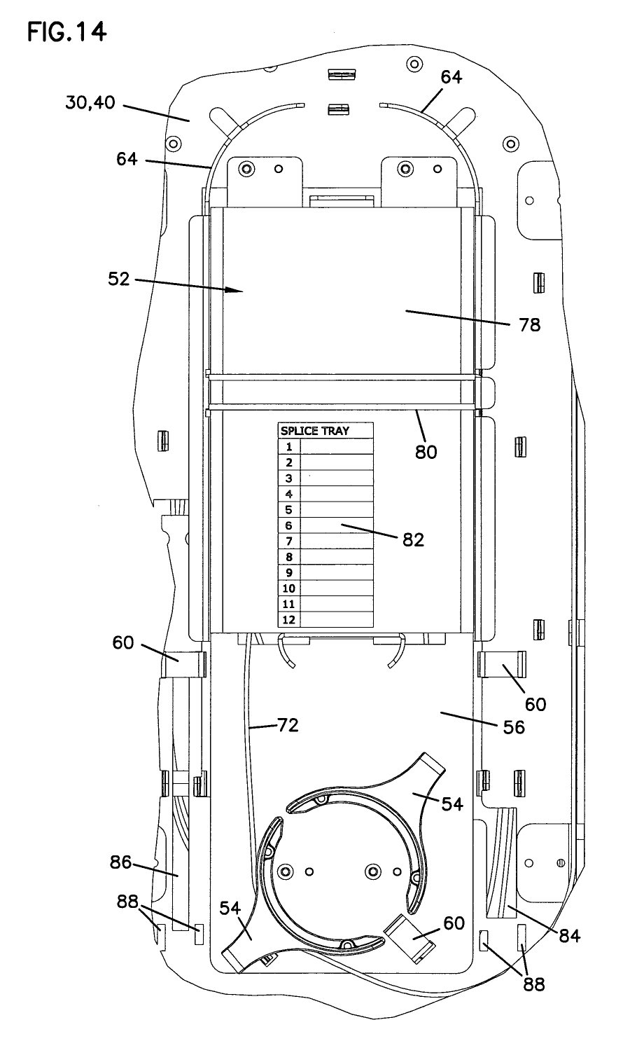

Referring now to FIG. 14, splice holder 52 includes a splice tray receiving pocket 78. Splice trays may be mounted within pocket 78 generally parallel to drop cable side 40 of frame 30. A reference label 82 may be included to permit users to indicate the connections made in splice trays placed in splice holder 52. A splice-tray retainer 80 may be included which extends across splice holder 52 to help contain splice trays within splice pocket 78. A plurality of opening pairs 88 are included about frame 30 and may be engaged by cable routing clips 60, which may be extended on either side 40 or 42 of frame 30. Pass-through openings 84 and 86 are provided to permit optical fibers such as optical fibers 72 to be extended from one side of frame 30 to the other.

As can be seen in FIG. 13, two cable routing paths are defined about splice holder 52. A first outer cable path is defined along the outer edge of frame 30 by cable tie-offs 62 and optical fibers 72 from drop cable 70 are contained within this cable path. A second cable path is defined along the outer edges of splice holder 52 by curved upper portions 64 at the top and by cable routing clips 60 along the sides. These two cable paths permit different optical fibers to be segregated and organized as desired in the field and also to permit fibers extending from drop cables 70 to splice holder 52 to be segregated from any pigtails or other cables extending from splice holder 52 through a pass-through opening to the other side of frame 30.

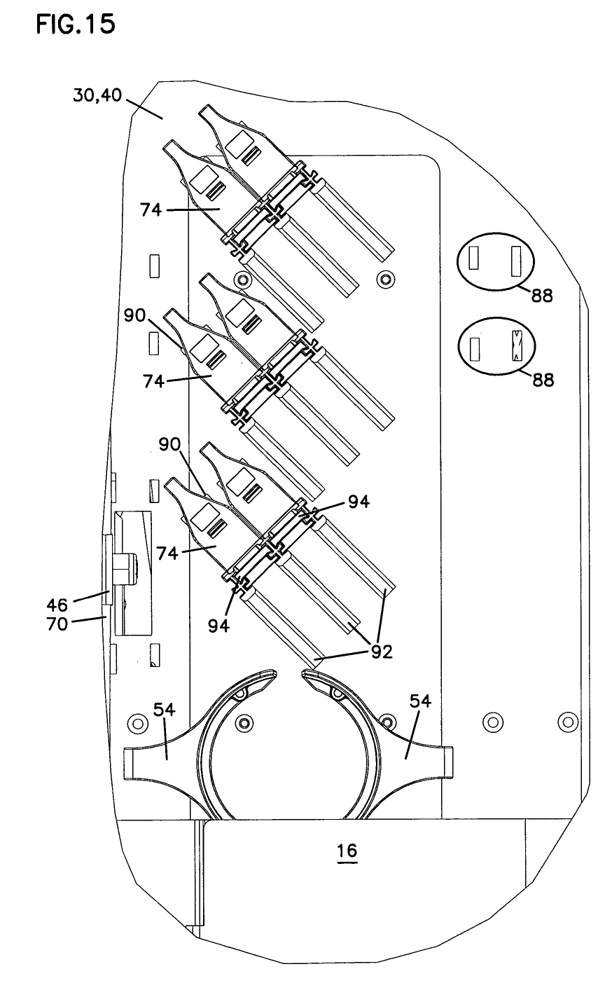

Referring now to FIG. 15, adapter packs 74 as shown each include a pair of fiber adapters 90 which are mounted through a plate 94 which engages and selectively slides a pair of supports 92 extending from plate 76. Commonly owned U.S. Pat. Nos. 5,497,444, 5,717,810, 5,758,003 and 6,591,051, the disclosures of which are incorporated herein by reference, further describe and show the structure and arrangement of adapter packs such as adapter pack 74.

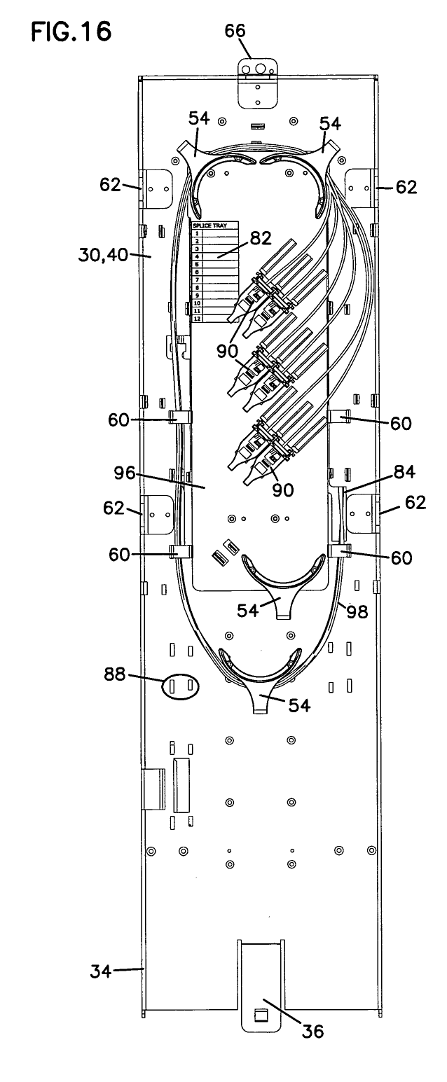

FIGS. 16 to 18 illustrate a further alternative configuration of structures mounted to drop cable side 40 of frame 30. In FIGS. 16 to 18, a plate 96 has been mounted in place of splice holder 52 and a plurality of adapter packs 74 and a plurality of cable management structures 54 are mounted to plate 96. In FIG. 16, a plurality of optical fibers 98 extend through opening 84 from distribution side 42 of frame 30 and are routed through several cable routing clips 60 and a cable management structure 54 mounted to frame 30 to one side of adapters 90 of adapter packs 74. These optical fibers 98 are connected within optical fibers within a distribution cable extending into enclosure 12 and engaging distribution cable side 42 of frame 30 as will be described below. Optical fibers 98 are routed within an inner cable path defined by cable routing clips 60 and several cable management structures 54. Label 82 may be included in this arrangement to provide indicia of the connection made between distribution and drop cables.

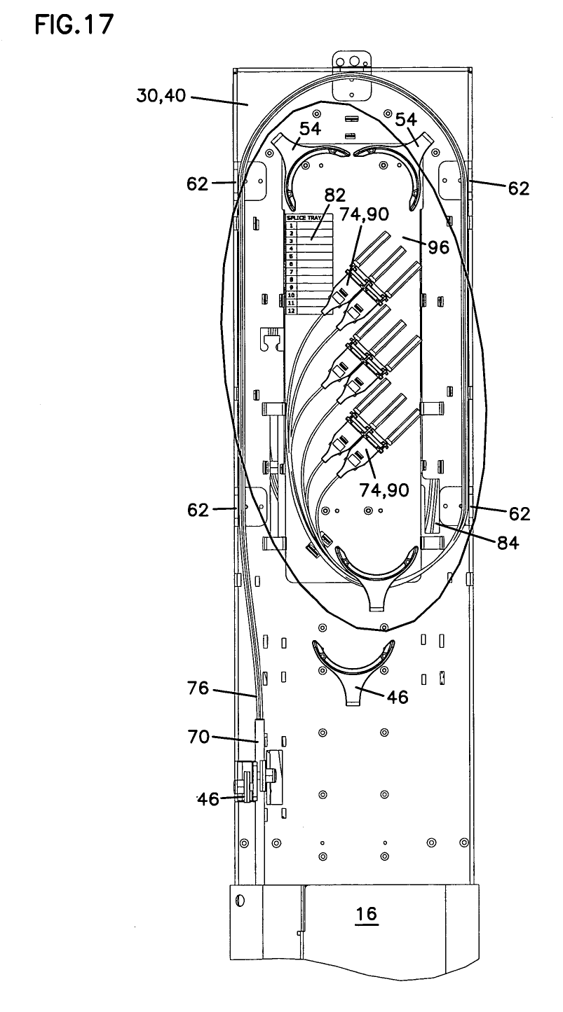

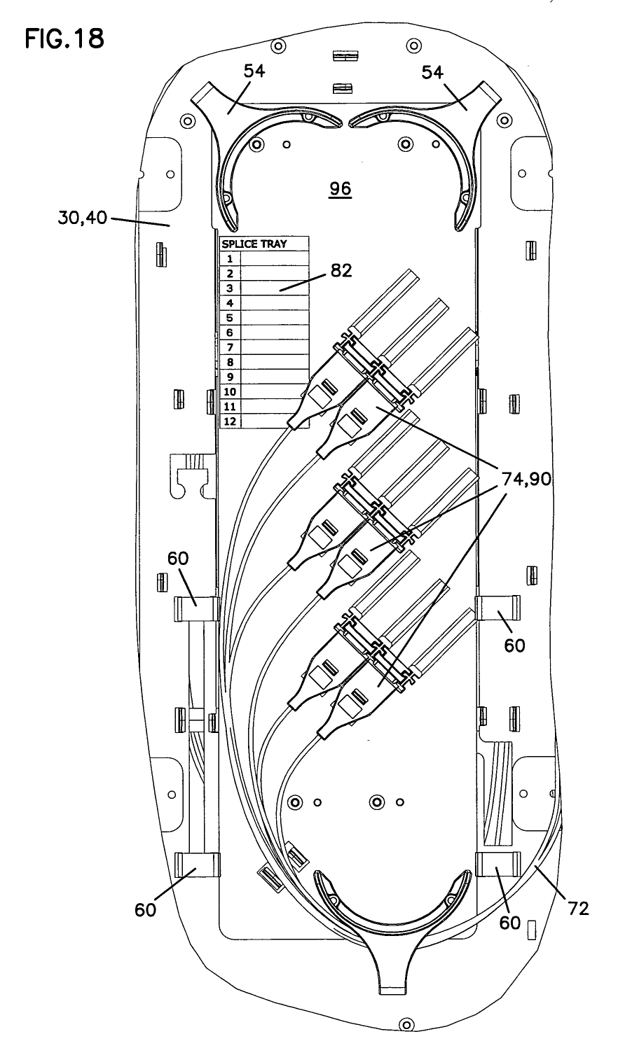

In FIGS. 17 and 18, optical fibers 98 have been removed and customer drop cables 70 with optical fibers 72 are shown. Optical fibers 72 extend from drop cables 70 about an outer cable path defined by tie-offs 62 and one of the cable management structures 54 and are directed to adapter packs 74 on an opposite side of adapters 90 from optical fibers 98. The two distinct cable routing paths on side 40 of frame 30 permit segregated routing of optical fibers from different sources, such as optical fibers 72 and 98.

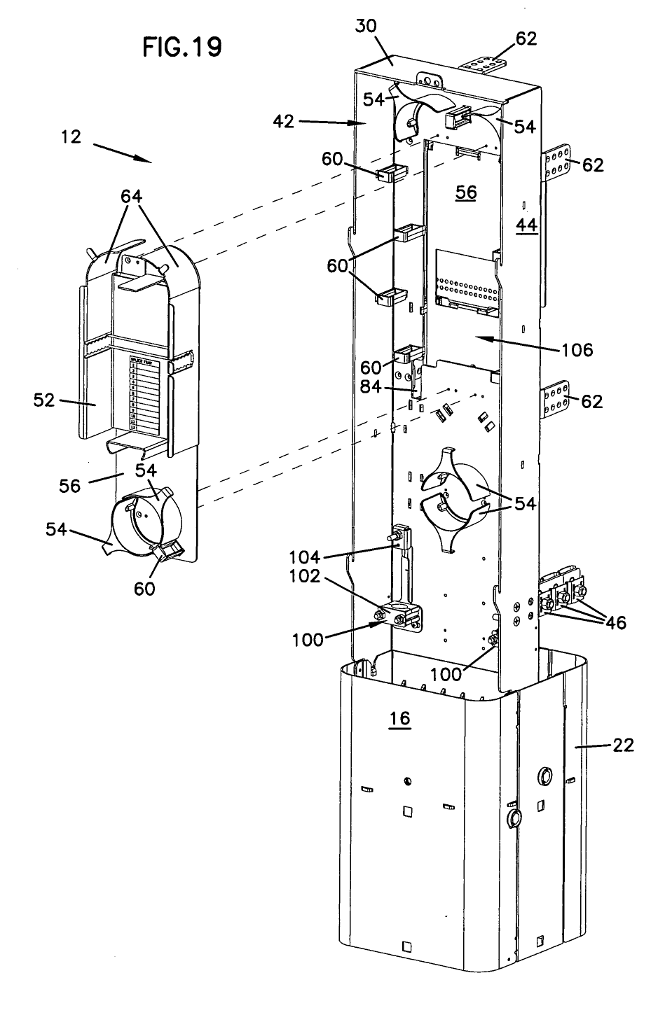

Referring now FIG. 19, distribution side 42 of frame 30 is shown with cover 32 removed. A cable clamp 100 is mounted to frame 30 adjacent a lower corner of each both extensions 44 to permit an entering and an exiting distribution cable to be secured to enclosure 12. Cable clamp 100 as shown includes a first clamp 102 for engaging an outer sheathing of a distribution cable and a second clamp 104 for engaging and securing a longitudinal strength member with the distribution cable. A plurality of cable routing clips 60 and cable management structures 54 are mounted to side 42 to provide multiple routing paths for optical fibers and cables. A splice holder 52 on plate 56 is also mounted to side 42 to permit certain optical fibers of distribution cables to be spliced to pigtails or other optical fibers for connection with customer drop cables on side 40 of frame 30.

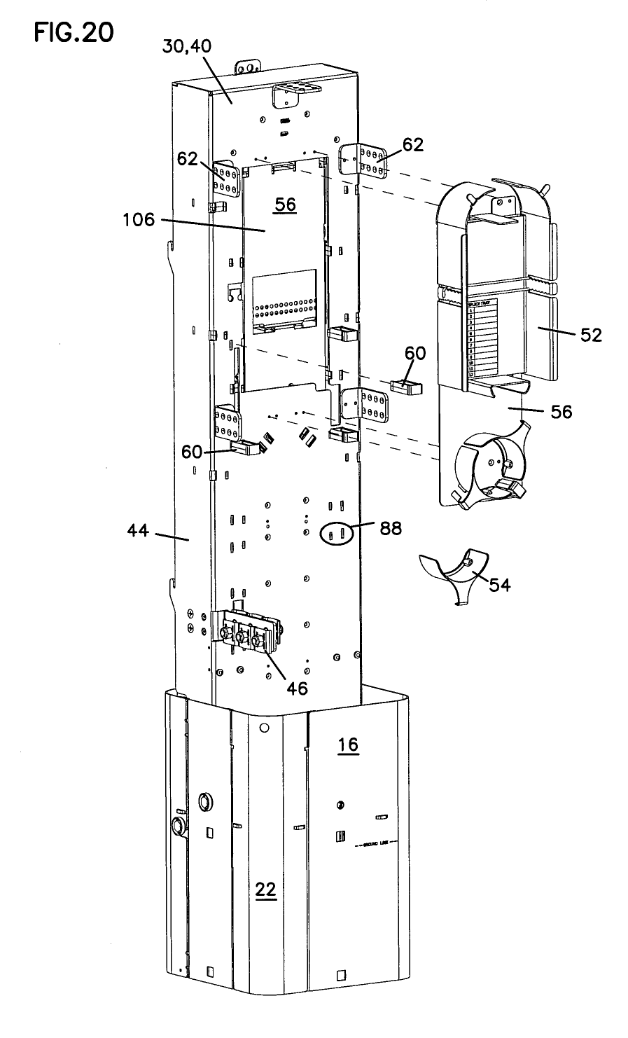

As can be seen in FIGS. 19 and 20, plates 56 are mounted over and close off at least some portion of an opening 106 between sides 40 and 42 of frame 30. Pass through opening 84 is an extension of this opening 106 and is preferably not covered by either plate 56. Frame 30 includes a plurality of openings such openings 106, 84, 88, as well as other fastener or other openings to permit a wide variety of cable routing, management, clamping and connection devices to be secured to either side 40 or 42 of frame 30 as required or desired for a particular installation. The range of openings permit the attachment of structures to define multiple cable paths on each side to permit segregation of cables and optical fibers. Structures supporting different connection types may also be mounted to either side 40 or 42. For example, on distribution side 40, drop cables may be pre-connectorized. This arrangement would not require splice holder 52 on side 42, but adapters 90 and adapter packs 74 may be mounted to side 40, such as shown in FIGS. 16 to 18. It may be desirable to splice an optical fiber of a distribution cable to a pigtail on side 42, direct the pigtail through opening 84 to be spliced to an optical fiber of a customer drop cable. Such an arrangement would require splice holders 52 on each side of frame 30 but no adapters 90 or adapter packs 74, such as shown in FIGS. 19 and 20. It may be desirable to only require one splice to connect each optical fiber of a distribution cable to an optical fiber of a drop cable, so that a splice holder 52 is only required on one side of frame 30.

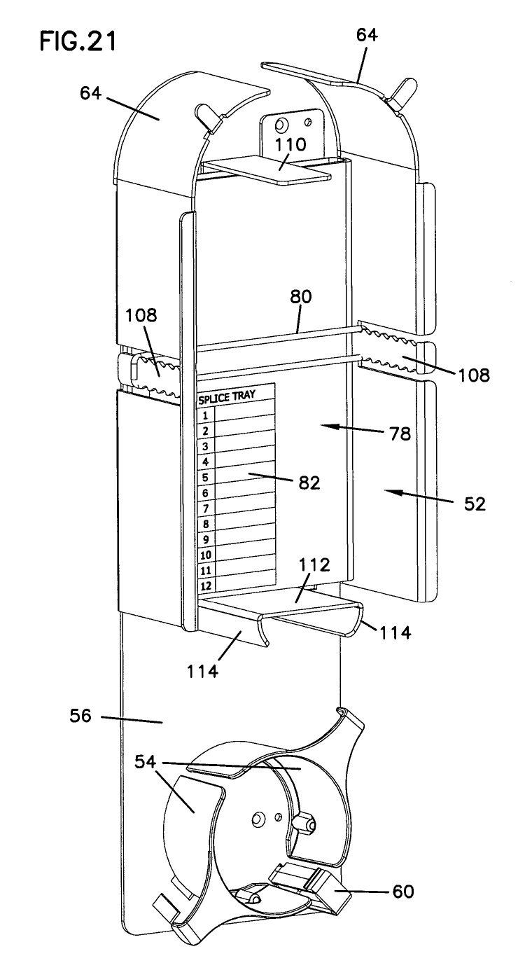

Referring now to FIG. 21, plate 56 and splice holder 52 mounted to plate 56 are shown. In addition to the elements described above, splice holder 52 also includes a pair of side tabs 108 about which splice tray retainer 80 is positioned. As shown, side tabs 108 are scalloped or otherwise define retainer stops to prevent slippage of retainer 80. An upper tab 110 and a lower tab 112 define upper and lower limits for splice pocket 78 and aid positioning of splice trays within splice holder 52. Lower tab 112 includes a pair of side wings 114 to aid in the direction of optical fibers to and from splice trays within splice pocket 78.

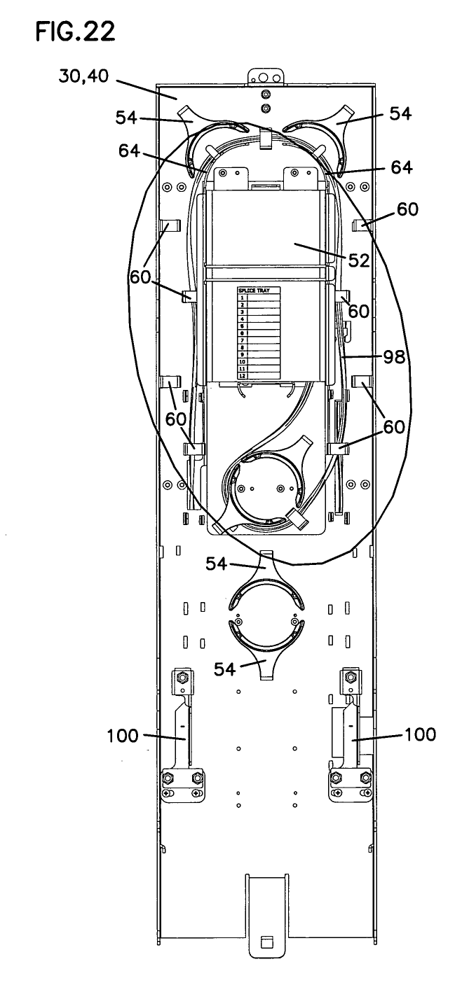

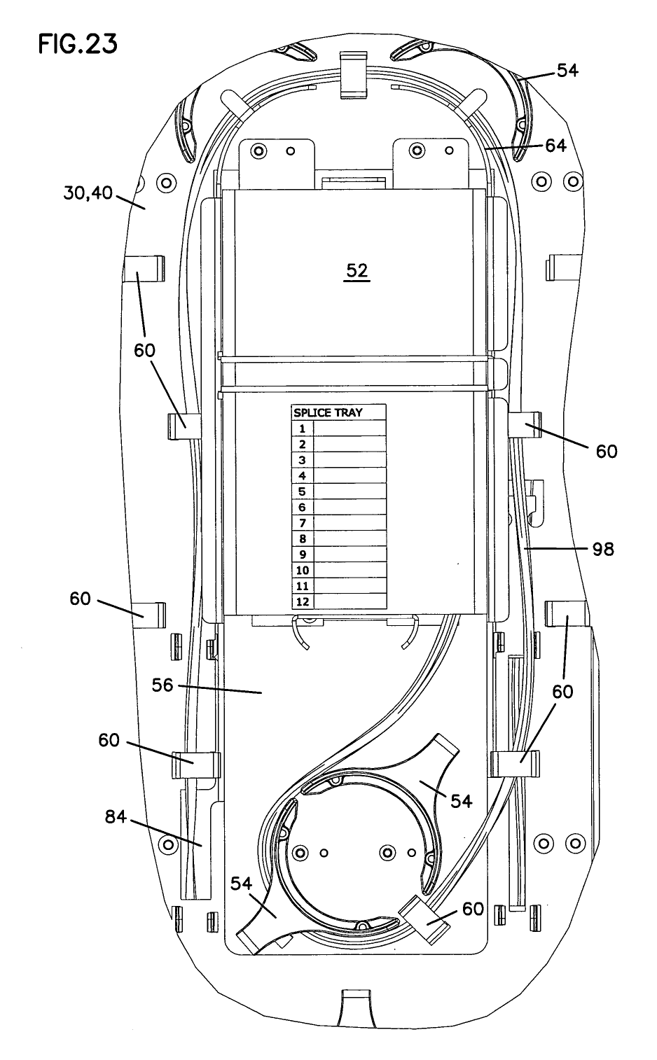

FIGS. 22 and 23 illustrate routing of optical fibers such as pigtails 98 from splice holder 52 in side 42 to pass through opening 84 to be extended to side 40 of frame 30. Pigtails or optical fibers 98 are directed from splice holder 52 about cable management structures 54 near the bottom of plate 56 and into the inner cable routing path defined by the inner most cable routing clips 60 and curved upper portions 64. From this cable path, pigtails 98 are positioned for passing through opening 84 to drop cable side 40 of frame 30.

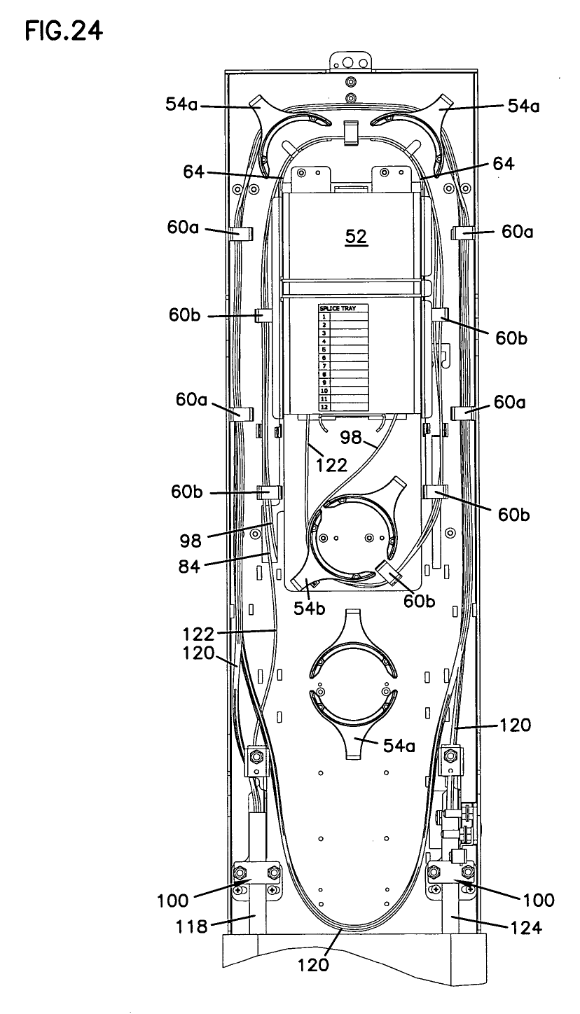

The remaining cable routing clips 60 as well as the upper and lower mounted cable management structures 54 define an outer cable routing path which may be used, for example, to route optical fibers 120 of a distribution cable 118 from one cable clamp 100 to the other cable clamp 100, such as shown in FIG. 24. In FIG. 24, incoming distribution cable 118 enters enclosure 12 and is clamped to the left cable clamp 100. Within cable 118 are a plurality of optical fibers 120 and 122, which may be bundled individually or may be packaged into a plurality of multi-fiber sub-units within cable 118. In FIG. 24, fibers 120 are expressed through enclosure 12, meaning that they are not broken or spliced to any other fibers within enclosure 12 but passed directly through to a departing distribution cable 124. These expressed through fibers 120 are routed about the periphery of frame 30 in the outer most cable path defined by cable routing clips 60a and cable management structures 54a.

Those optical fibers 122 of cable 118 which are to be connected to customer drop cables within enclosure 12 are routed through the inner most cable path defined by cable routing clips 60b, cable management structures 54b and upper curved portions 64 of splice holder 52. These optical fiber 122 are directed to splice holder 52 for connection with pigtails 98, which are in turn directed through the inner most cable path to opening 84 for extension to side 40 of frame 30.

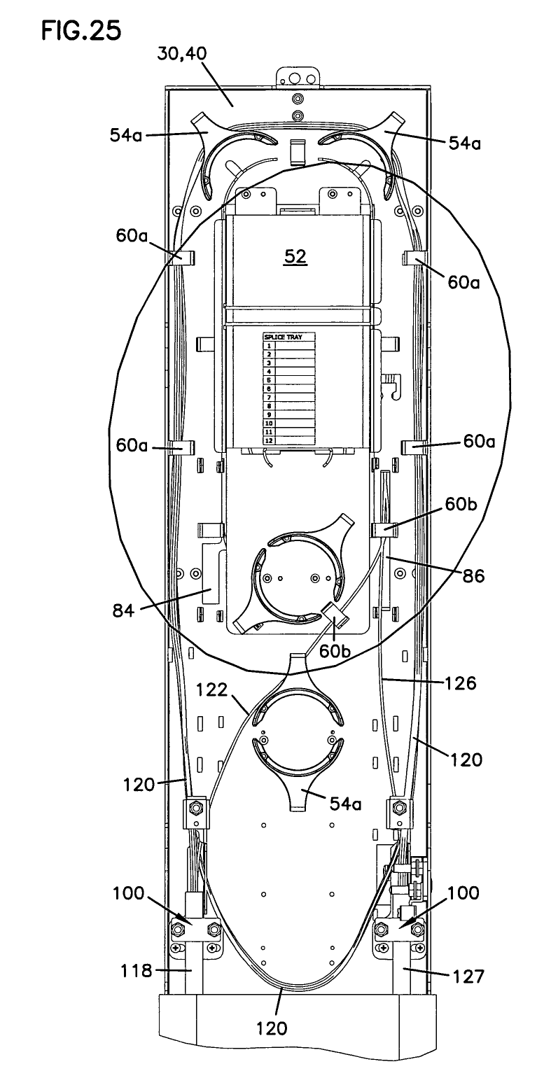

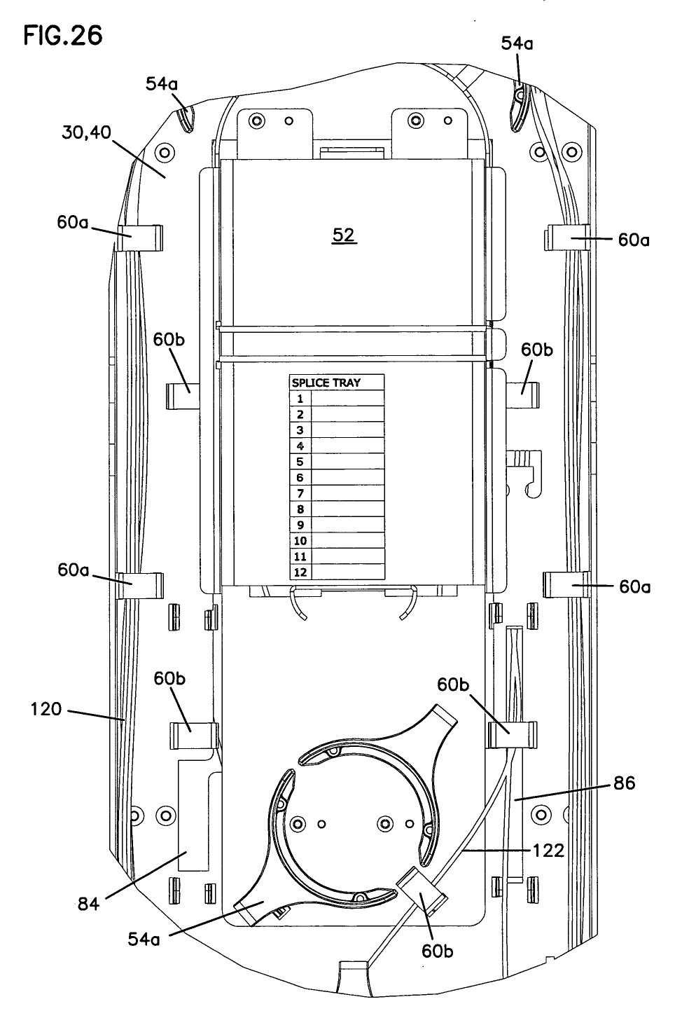

FIGS. 25 and 26 illustrate an alternative routing of optical fibers on side 42 with the same configuration of structures mounted to side 42 of frame 30. In this example, cable 118 includes both expressed through fibers 120 and broken out fibers 122. Fibers 120 are routed as described above. Fibers 122 are routed directed from clamp 100 to opening 86 and extended through to side 40 of frame 30. From opening 86, fibers 122 may be directed to splice holder 52 on side 40, spliced to a fiber 72 of a customer drop cable 72.

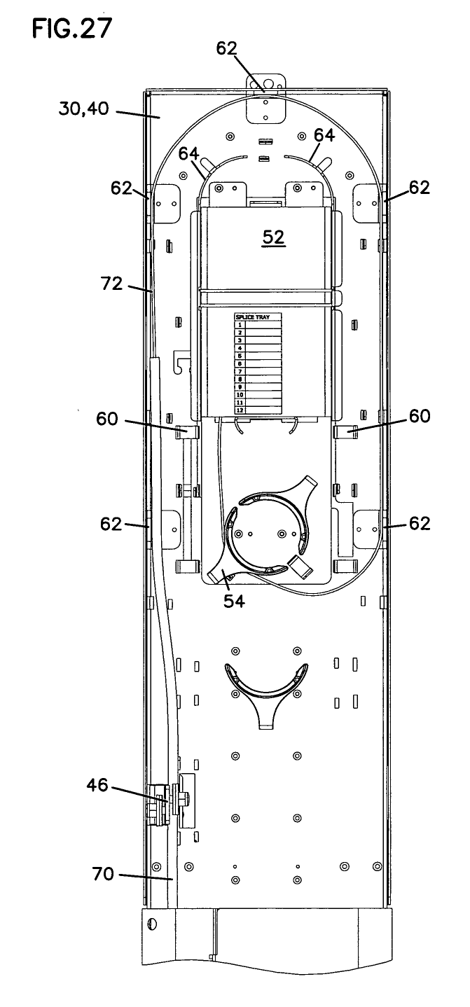

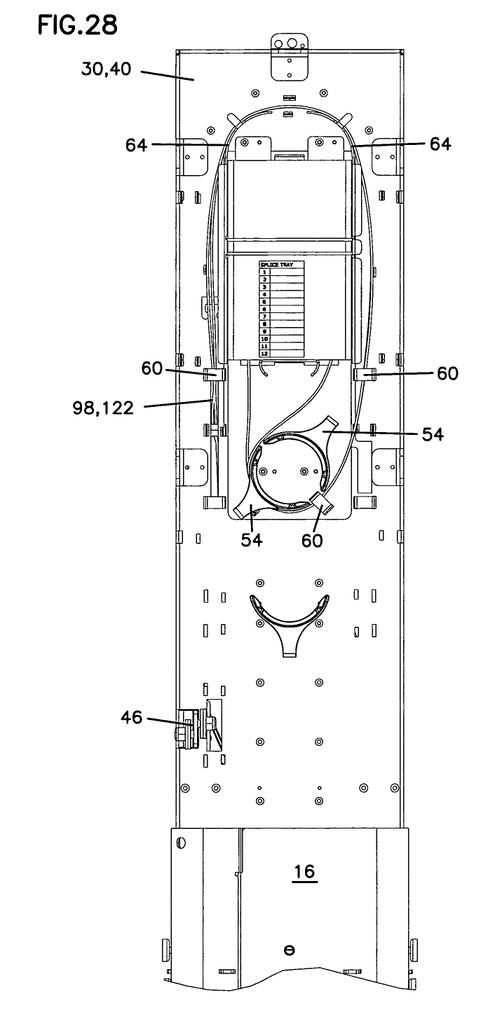

FIGS. 27 and 28 illustrate the segregation of fibers on the drop cable side of frame 30. In FIG. 27, drop cable 70 is clamped at clamp 46 and both drop cable 70 and then optical fiber 72 of cable 70 are directed into and held in the outer most cable path by cable tie-offs 62 until optical fiber 72 is directed to splice holder 52 for splicing to a broken out fiber 122 of distribution cable 118 or a fiber pigtail 98 from splice holder 52 on side 42. In FIG. 28, regardless of which of optical fibers 122 or 98 extend from side 42, these optical fibers are directed into the inner most cable path from opening 84 or 86 and routed to splice holder 52 through cable routing clips 60 and upper curved portions 64. Within splice holder 52, these optical fibers from the drop cables may be connected with the optical fibers from the distribution cables.

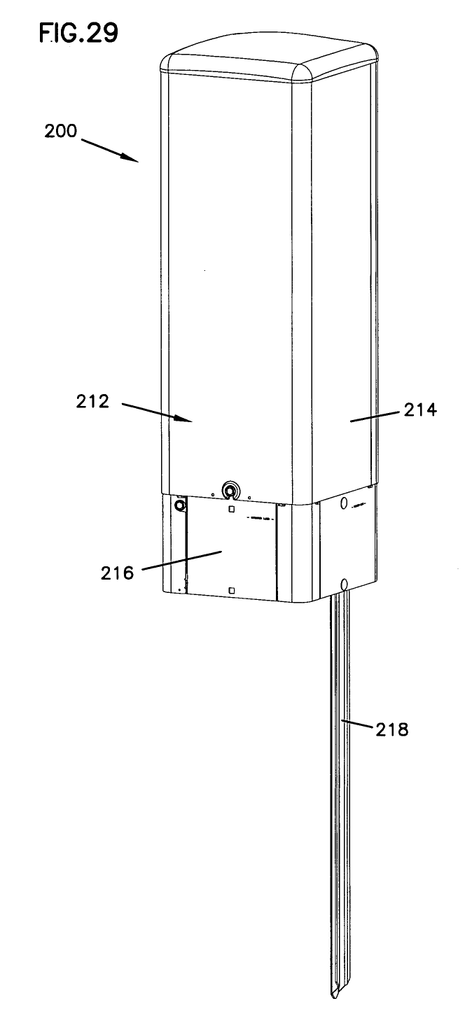

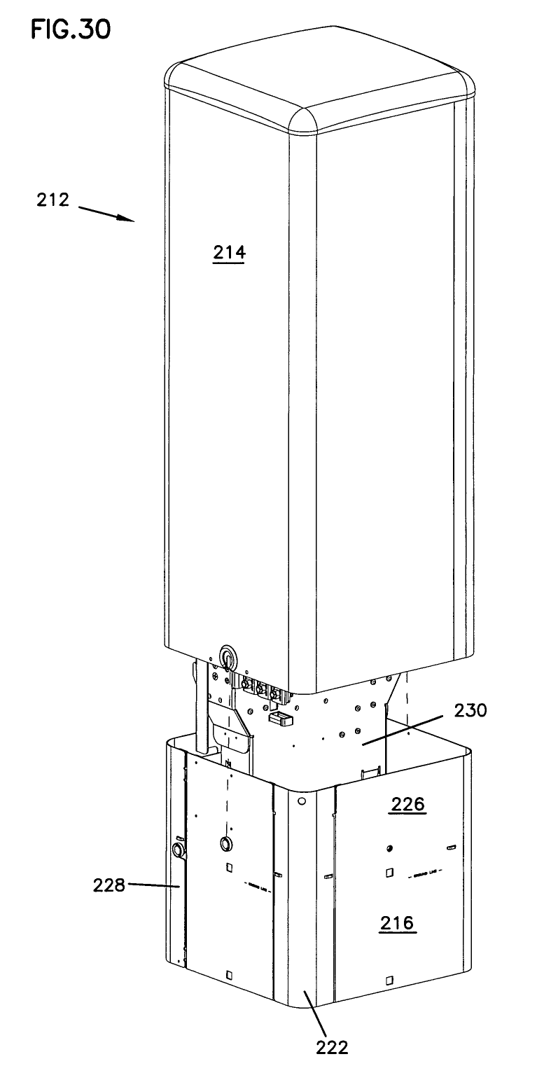

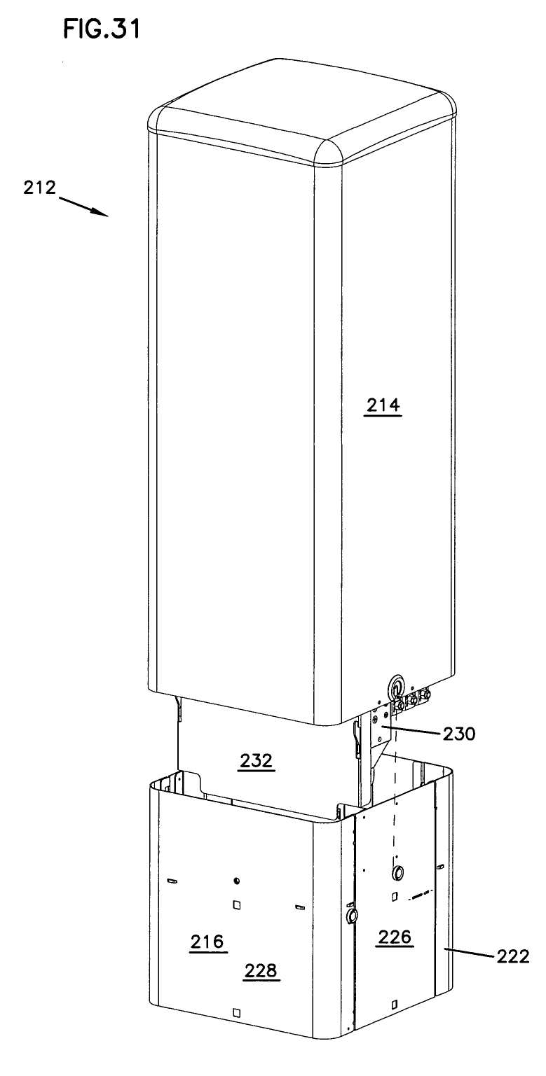

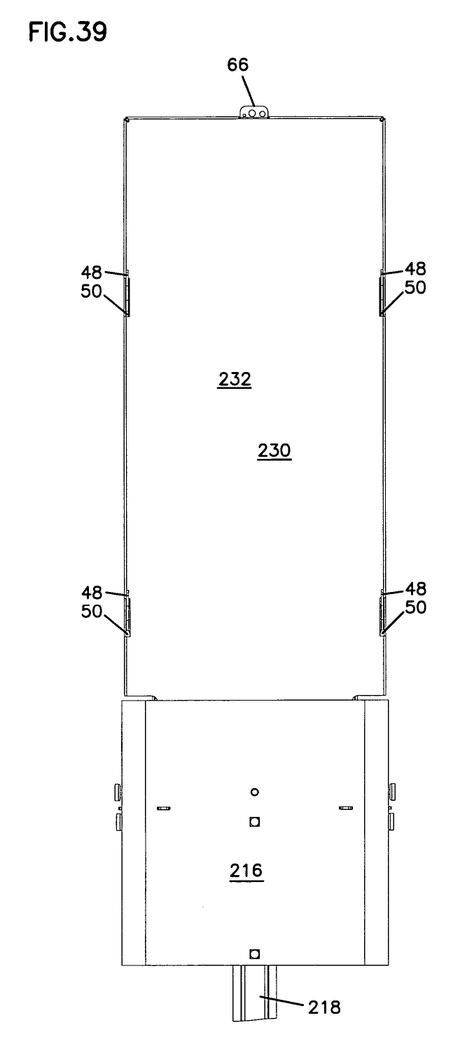

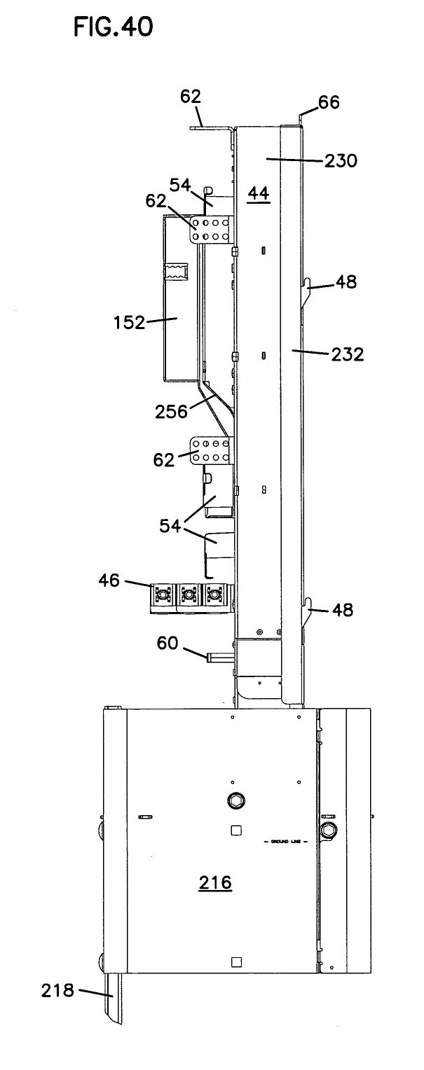

Referring now to FIGS. 29 to 44, an alternative embodiment fiber access terminal 200 includes an enclosure 212, a removable cover 214, a base 216 and a mounting stake 218. Terminal 200 is different size format from terminal 100, described above but includes many of the same structural elements and features of terminal 100. FIGS. 30 and 31 illustrate terminal 200 with cover 214 partially removed showing a frame 230 within an interior. Base 216 includes a first fixed portion 226, a second removable portion 228 and a removable corner 222. A distribution side cover 232 is mounted to one side of frame 230.

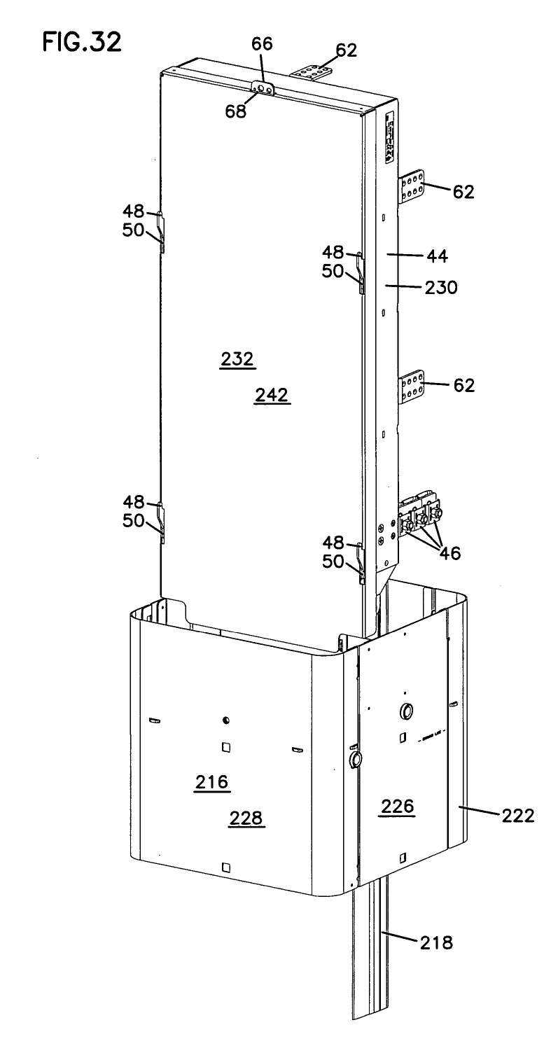

FIG. 32 illustrates base 216 and frame 230 with cover 214 removed. Cover 232 is held to a second side 242 of frame 230 by hooks 48 of frame 230 engaging openings 50 of cover 232. Lock tab 66 of frame 230 extends through an opening 68 of cover 232 and permits cover 232 to be secured to frame 230 to prevent access to second or distribution side 242.

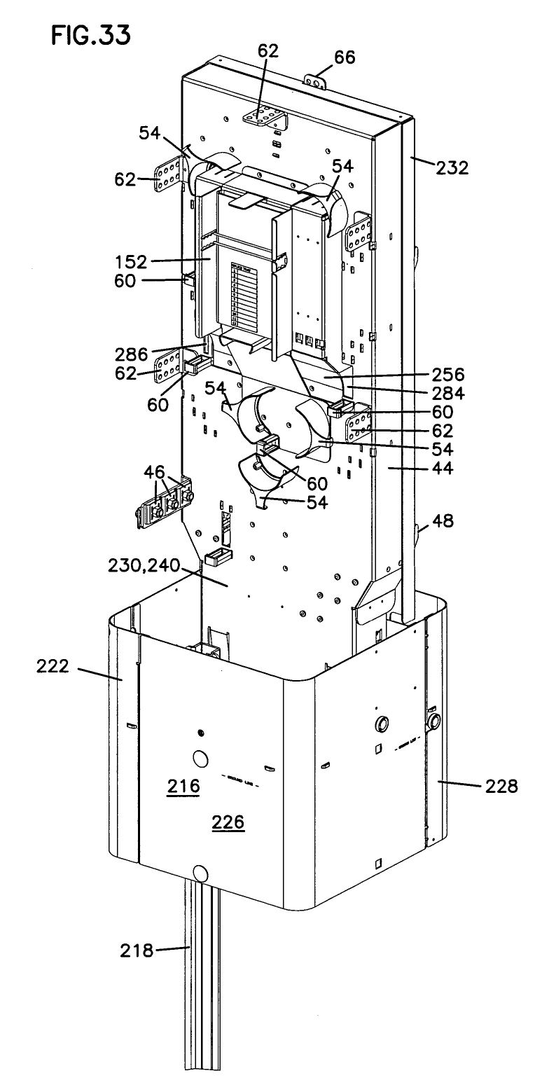

FIG. 33 illustrates a first side or drop cable side 240 of frame 230 which includes a splice holder 152 mounted adjacent a plate 256. Pass-through openings 284 and 286 permit optical fibers and cables to pass from one side of frame 230 to the other side. Splice holder 152 does not provide curved upper portions so cable management structures 54 are positioned at the top of splice holder 52 on either side to define a cable path about splice holder 52.

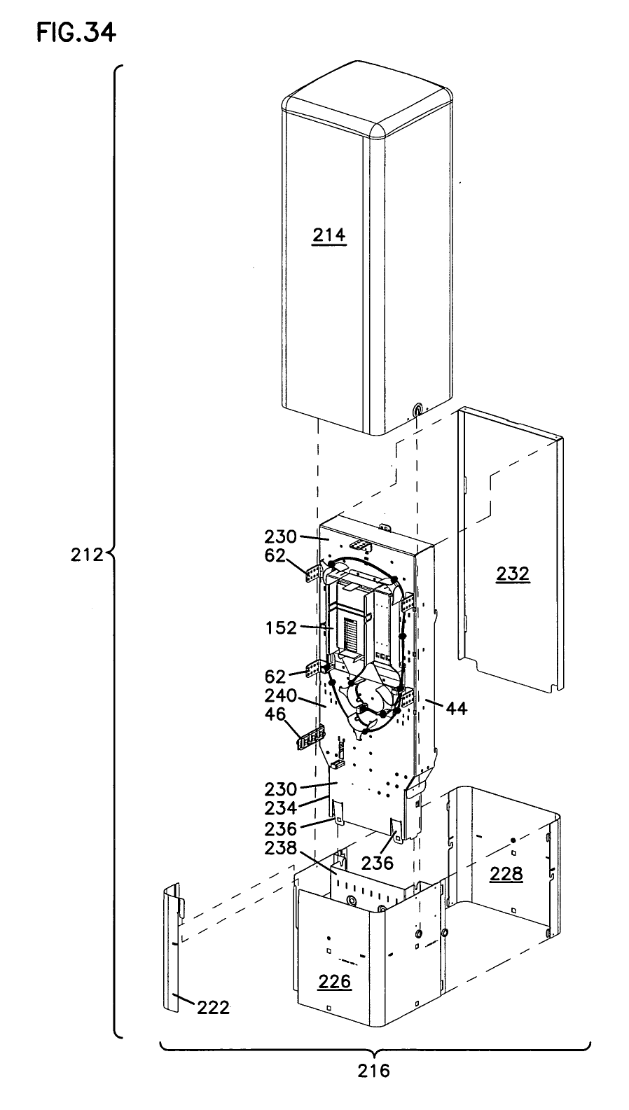

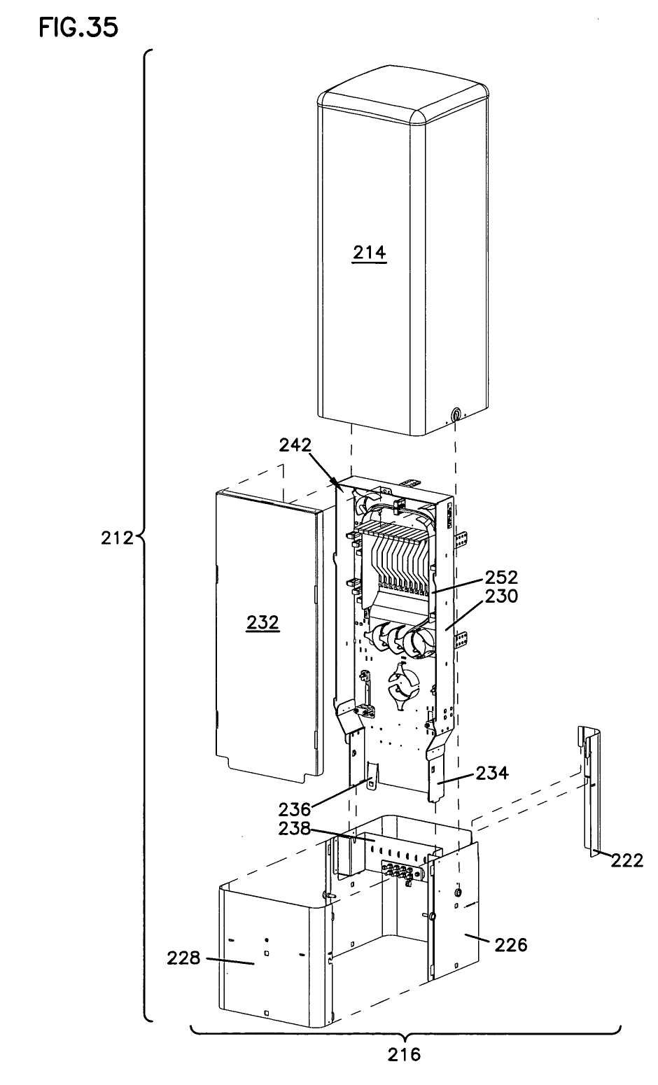

FIG. 34 shows a lower portion 234 of frame 230 with locking tabs 236 and a frame mount 238 within base 216. FIG. 35 shows distribution cable side 242 of frame 230 includes a branching splice holder 252. Splice holder 252 holds splice trays similar to that used with splice holder 152 and described above. However, splice holder 252 holds these trays generally perpendicular to side 242 of frame 230, so that any of the trays may be accessed without removing or disturbing any of the other trays. Splice holder 152, such as shown on side 240 of frame 230, holds the trays one atop the other generally parallel to side 240. This arrangement may requires the removal of other trays to access a desired tray, unless the tray to be accessed in the outer most tray.

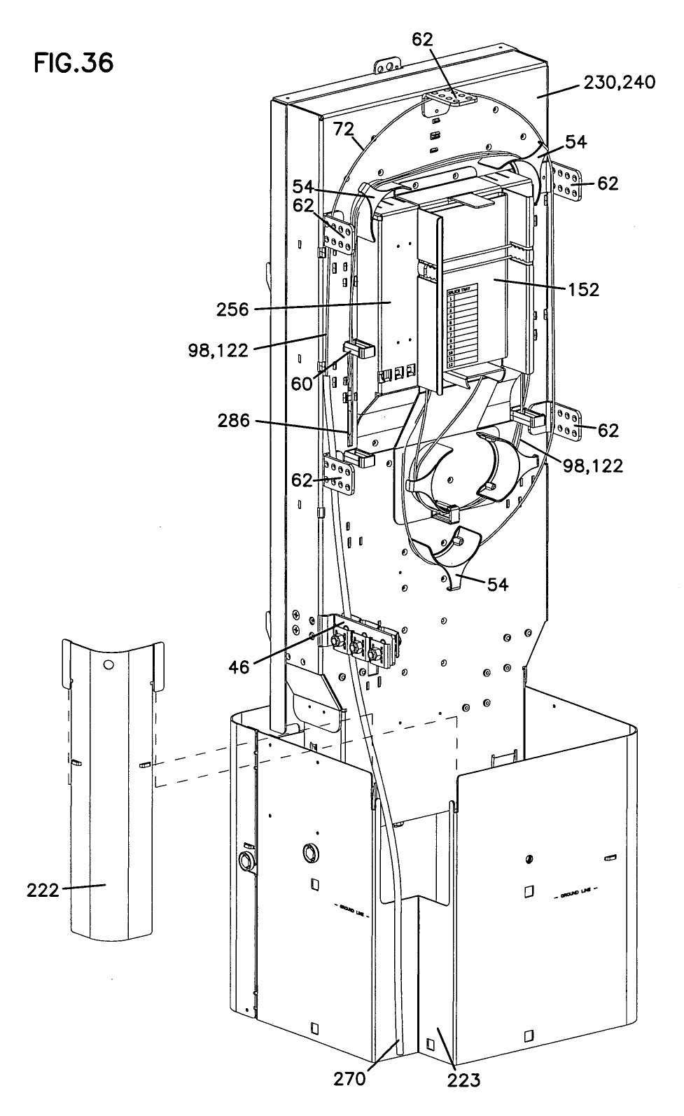

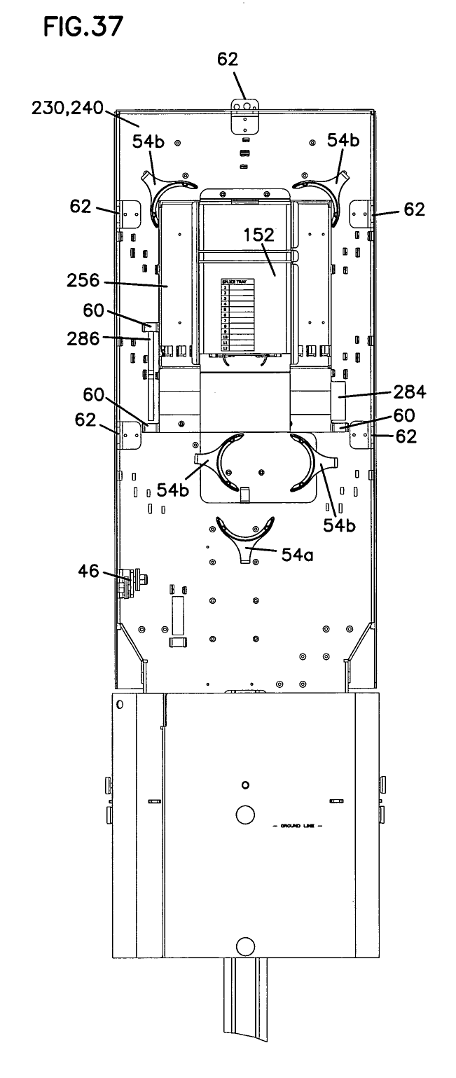

FIG. 36 shows removable corner 222 removed from base 216 to permit a new customer drop cable 270 to routing into enclosure 212. Comer 222 permits new drop cable 270 to be connected into optical fibers within enclosure 212 without having to remove or disturb base 216. New drop cable 270 may be trenched to a point adjacent enclosure 212. Cover 214 is removed, permitting corner 22 to be removed from base 216. Drop cable 270 can then be positioned within a recessed corner 223 and passed over base 216 into enclosure 212 and routed to clamp 46. From there, drop cable 270 is handled in the same manner as drop cables 70, described above. Referring now also to FIG. 37, the outer most cable path of frame 230 is defined by tie-offs 62 about the periphery of frame 230 on side 240 and passes also about a lower cable management structure 54a as it directs optical fiber 72 from drop cable 70 to splice holder 152. The inner most cable routing path is defined by cable management structures 54b and cable routing clips 60 to direct optical fibers 98 or 122 from pass through openings 284 or 286 to splice holder 152.

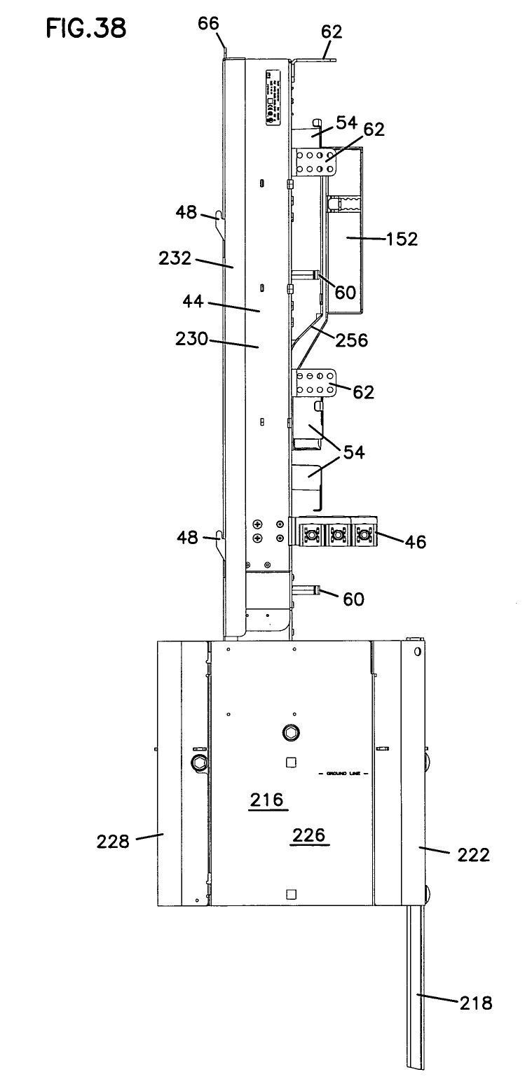

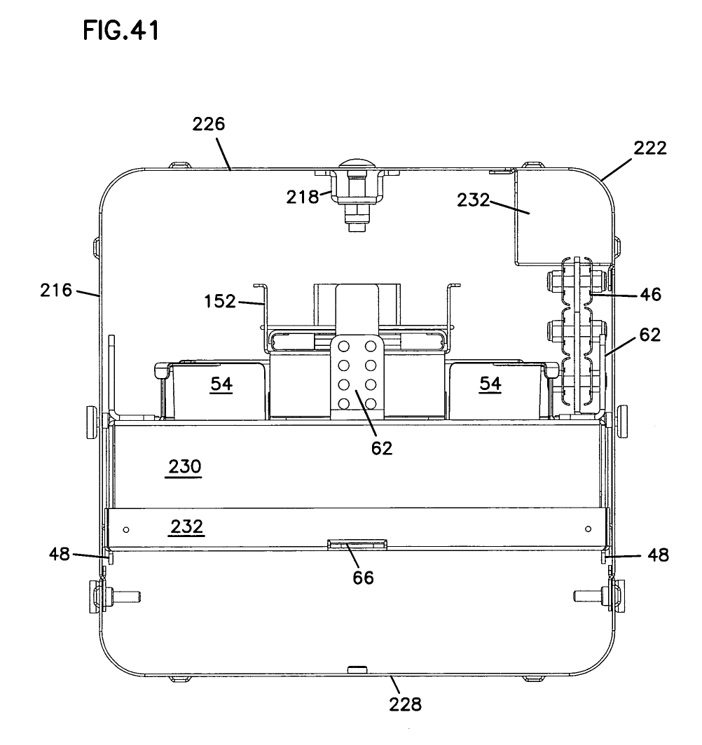

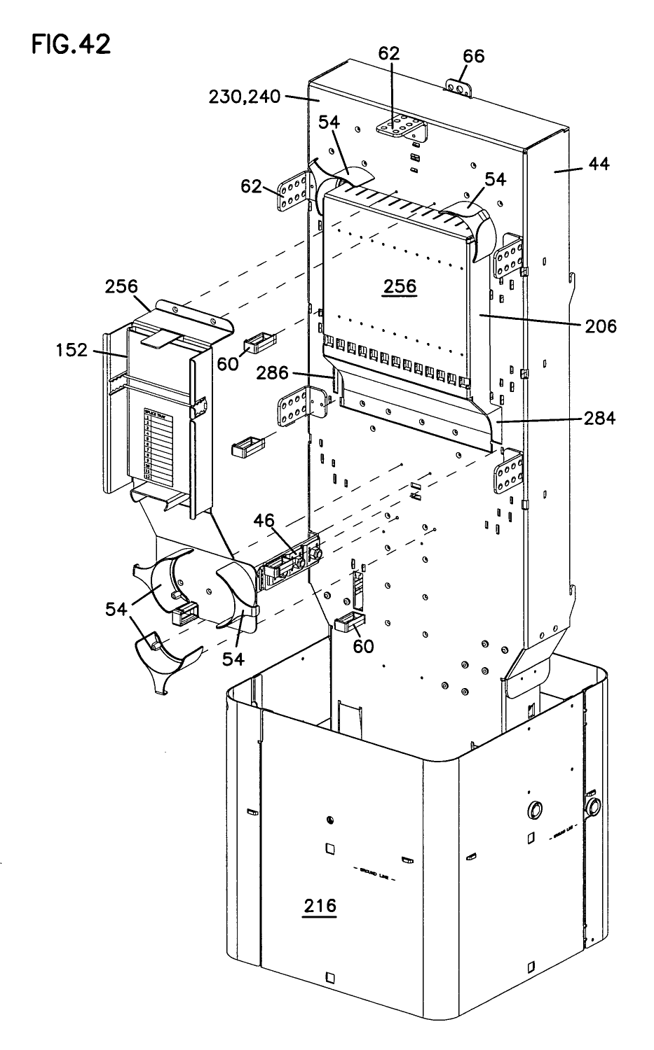

FIGS. 38 to 41 illustrate the side and top views of base 216 and frame 230 and show the general location and layout of the various components mounted to drop cable side 240 of frame 230. Also visible in FIG. 41 is recessed corner 223 of base 216 where new drop cables 270 may be directed into enclosure 212. FIG. 42 is an exploded view of the structures mounted to side 240 of frame 230.

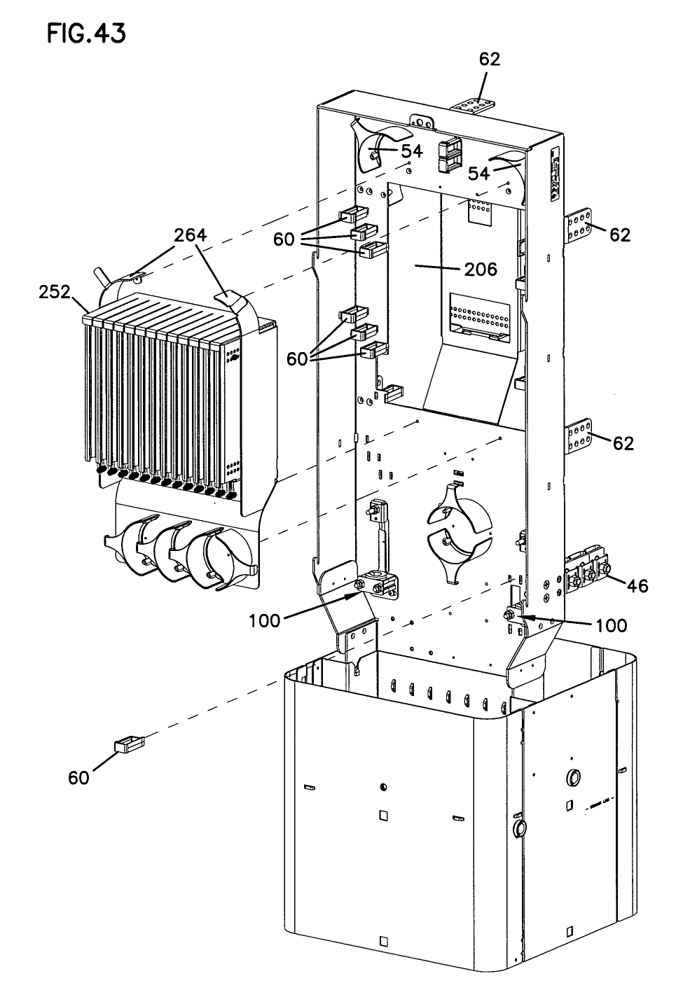

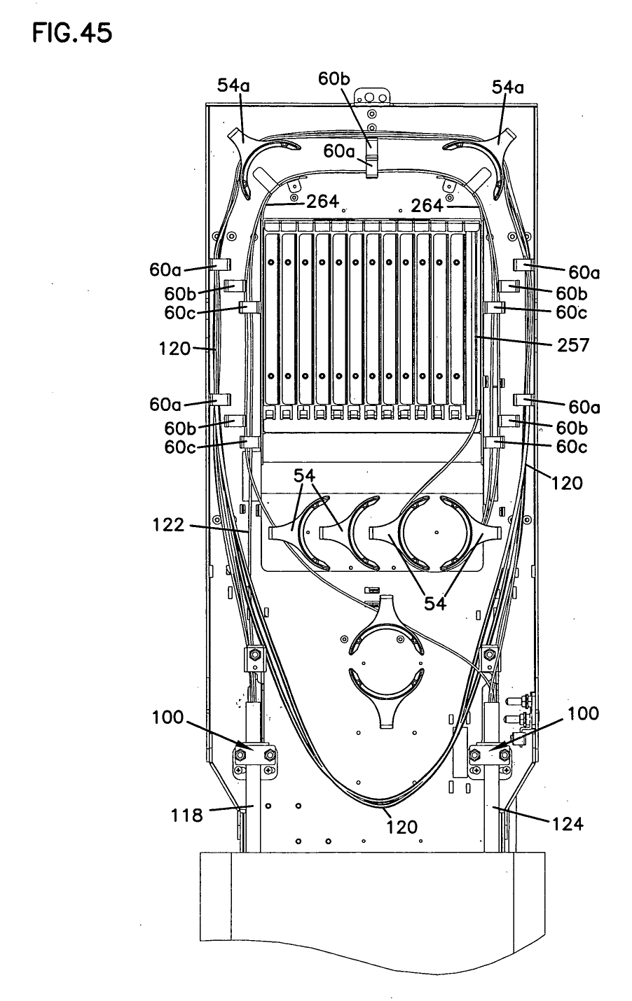

FIG. 43 is an exploded view of the structures mounted to side 242 of frame 230 with cover 232 removed. Side 242 includes a plurality of cable routing paths about splice holder 252 defined by different sets of cable routing clips 60. An opening 206 is defined in frame 230 and permits plate 256, which a back wall of splice holder 252, to extend through frame 230 from distribution cable side 242 to drop cable side 240. This is necessary to provide enough depth of splice holder 252 to accommodate the width of a splice tray 257 (shown in FIG. 45) which are held perpendicular to frame 230 and remain within a footprint of base 216. This permits cover 214 to have the same footprint as base 216 and not require a bulge or extension to accommodate the increased depth of splice tray 257.

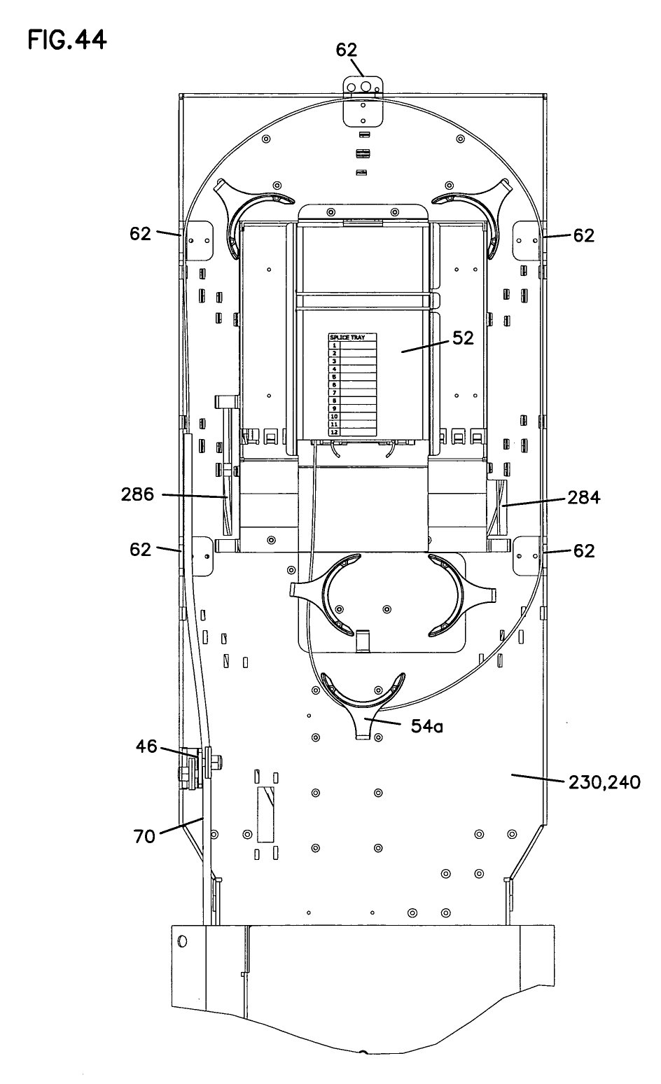

FIG. 44 illustrates the routing of customer drop cable 70 and optical fibers 72 of cable 70 about side 240 of frame 230. Drop cable 70 and optical fiber 72 are directed from cable clamp 46 about the periphery of side 240 where it is secured at the various tie-offs 62. It passes about cable management structure 54a and is directed to splice holder 152.

FIG. 45 illustrates how fiber distribution cables 118 and 124, and optical fibers 120 and 124 are is routed on side 242. From cable clamp 100, expressed optical fibers 120 are routed through an outer most cable routing path defined by cable routing clips 60a and cable management structures 54a about the periphery of side 242 and to distribution cable 124 secured at the other cable clamp 100. Fiber 122 which are broken out of cable 118 for connection with enclosure 212 are routed into one of two inner cable paths defined respectively by cable routing clips 60b and 60c. It is anticipated that some of the fibers 122 within cable 118 are to be branched to other and connected to other distribution cables within enclosure 212. The definition of two inner cable paths in addition to the express cable path, permits segregation of fibers being directed on side 242 within enclosure 212 for multiple purposes. The inclusion of multiple cable management structures 54 directly beneath splice holder 252 allows for more direct and protected routing of cables to and from splice trays 257 that may be held by splice holder 252.

Although preferred embodiments have been shown and described, many changes, modifications, and substitutions may be made by one having skill in the art without unnecessarily departing from the spirit and scope of the present invention. Having described preferred aspects and embodiments of the present invention, modifications and equivalents of the disclosed concepts may readily occur to one skilled in the art. However, it is intended that such modifications and equivalents be included within the scope of the claims which are appended hereto.

What is claimed is:

1. A fiber access terminal comprising:
an enclosure including a base and a cover sized to engage the base, the base and the cover defining an interior and a frame extending from the base within the interior;
the frame having a first side and a second side, each side adapted to receive cable management structures and fiber connection devices;
a distribution cable entering the enclosure on the first side of the frame, the distribution cable including a plurality of optical fibers, the distribution fiber entering the enclosure through the base and passing into the interior;
the second side adapted to receive at least one of the optical fibers of the distribution cable from the first side and including a means of connecting the at least one optical fiber to a customer drop cable entering the enclosure through the base on the second side of the frame.

2. The fiber access terminal of claim 1, further comprising a cable clamp on the first side of the frame securing the distribution cable to the frame, the cable clamp adapted to secure an outer covering of the distribution cable and to secure an internal strength member of the distribution cable.

3. The fiber access terminal of claim 1, further comprising a splice holder mounted to the first side of the frame and a plurality of cable management structures mounted to the frame defining a plurality of cable routing paths about the splice holder for the optical fibers of the distribution cable.

4. The fiber access terminal of claim 3, wherein at least two cable paths are defined on the first side of the frame, one of the cable paths for routing optical fibers from the distribution cable entering the enclosure to a second distribution cable exiting the enclosure and one of the cable paths for routing optical fibers from the distribution cable to the splice holder on the first side of the frame.

5. The fiber access terminal of claim 4, further comprising a splice holder mounted to the second side of the frame and cable management structures mounted on the second side of the frame defining a cable routing path for an optical fiber from the first side of the frame to the splice holder.

6. The fiber access terminal of claim 5, further comprising at least one fiber optic adapter mounted to the second side of the frame and the cable management structures mounted to the second side of the frame further defining a cable routing path from the splice holder of the second side of the frame to the fiber optic adapter.

7. The fiber access terminal of claim 3, wherein at least two cable paths are defined on the first side of the frame, one of the cable paths for routing optical fibers from the distribution cable entering the enclosure to a second distribution cable exiting the enclosure and one of the cable paths for routing optical fibers from the distribution cable to the second side of the frame; and
further comprising a splice holder mounted to the second side of the frame and cable management structures mounted to the second side of the frame defining a cable path for routing an optical fiber from the first side of the frame to the splice holder of the second side of the frame.

8. The fiber access terminal of claim 1, wherein a plurality of cable management structures are mounted to the first side of the frame and define a plurality of cable paths for optical fibers of the distribution cable, one of the cable paths for routing optical fibers from the distribution cable entering the enclosure to a second distribution cable exiting the enclosure and one of the cable paths for routing optical fibers from the distribution cable to the second side of the frame.

9. The fiber access terminal of claim 8, wherein a splice holder is mounted to the second side of the frame and the optical fibers from the distribution cable and the cable path of the first side of the frame are directed to the splice holder.

10. The fiber access terminal of claim 9, further comprising cable management structures mounted to the second side of the frame and defining a cable path for the optical fiber from the first side of the frame to the splice holder mounted to the second side of the frame.

11. The fiber access terminal of claim 10, wherein the cable management structures mounted to the second side of the frame also define a cable path from the splice holder to a cable entry for a customer drop cable entering the enclosure through the base on the second side of the frame.

12. The fiber access terminal of claim 4, further comprising at least one fiber optic adapter mounted to the second side of the frame and cable management structures mounted on the second side of the frame defining a cable routing path for the optical fiber from the first side of the frame to the fiber optic adapter.

13. The fiber access terminal of claim 1, further comprising a cover removably mounted about the first side of the frame within the enclosure to restrict access to the distribution cable and the plurality of optical fibers of the distribution cable on the first side of the frame.

14. The fiber access terminal of claim 3, wherein the splice holder mounted to the first side is configured to hold a plurality of splice trays substantially parallel to the first side of the frame.

15. The fiber access terminal of claim 3, wherein the splice holder mounted to the first side is configured to hold a plurality of splice trays substantially perpendicular to the first side of the frame.

16. The fiber access terminal of claim 9, wherein the splice holder mounted to the second side is configured to hold a plurality of splice trays substantially parallel to the second side of the frame.

17. The fiber access terminal of claim 9, wherein the splice holder mounted to the second side is configured to hold a plurality of splice trays substantially perpendicular to the second side of the frame.

18. The fiber access terminal of claim 1, wherein the first and second sides of the frame both include a plurality of openings and are configured to receive a plurality of cable management structures and splice holders which are mounted to the frame without requiring tools, the cable management structures and splice holders providing flexible configuration of cable routing and splicing for the optical fibers of the distribution cable on the first side of the frame and for optical fibers of customer drop cables extending into the enclosure on the second side of the frame.

19. A method of routing an optical fiber cable within a fiber access terminal comprising:
providing a fiber access enclosure with a frame having a first side and a second side, a base to which the frame is mounted and a removable enclosure cover configured to be positioned about the frame;
positioning a loop of a fiber distribution cable through the base adjacent a first side of the frame, the fiber distribution cable including a plurality of optical fibers within an outer sheathing;
clamping the fiber distribution cable to the first side of the frame;
removing the outer sheathing from about the optical fibers;
routing a first expressed through portion of the plurality of optical fibers through a first cable routing path;
routing a second portion of the plurality of optical fibers through a second cable routing path;
extending a customer drop cable including at least one optical fiber into the enclosure adjacent the second side of the frame;
optically connecting one of the optical fibers of the second portion with one of the optical fibers of the drop cable; and
placing the removable cover about the frame blocking access to both sides of the frame.

20. The method claim 19, further comprising splicing one of the optical fibers of the second portion to an intermediate optical fiber on the first side of the frame, extending the intermediate optical fiber through the frame to the second side of the frame and optically connecting the intermediate optical fiber to one of the optical fibers of the customer drop cable.

21. The method of claim 20, wherein the customer drop cable includes an outer sheathing and further comprising clamping the customer drop cable to the second side of the frame, separating the optical fibers of the customer drop cable from the outer sheath of the customer drop cable, and routing the optical fibers of the drop cable through a first cable routing path to a splice location on the second side.

22. The method of claim 21, further comprising routing the intermediate optical fiber in a second cable routing path on the second side of the frame to the splice location on the second side.

23. The method of claim 19, further comprising routing one of the optical fibers of the second portion through the frame to the second side of the frame and optically connecting the optical fiber of the second portion with one of the optical fibers of the customer drop cable.

24. The method of claim 23, wherein the optical fiber of the second portion is routed on the second side of the frame to a splice location and is spliced to one of the optical fibers of the customer drop cable.

25. The method of claim 19, wherein one of the optical fibers on the customer drop cable is terminated with a connector, the method further comprising splicing one of the optical fibers of the second portion to a fiber pigtail on the first side of the frame, the pigtail terminated with a fiber optic connector, extending the pigtail through the frame to the second side of the frame and optically connecting the connector of the pigtail with the connector of the customer drop cable.

26. The method of claim 19, further comprising placing an internal cover about the first side of the frame before placing the cover over both sides of the frame.
